(19) United States
(12) Patent Application Publication
(10) Pub. No.: US 2025/0310978 A1
(43) Pub. Date: Oct. 2, 2025

(54) METHODS AND APPARATUSES FOR SIDELINK COMMUNICATIONS

(71) Applicant: InterDigital Patent Holdings, Inc., Wilmington, DE (US)

(72) Inventors: Virgile Garcia, Antibes (FR); Hussain Elkotby, Conshohocken, PA (US); Pascal Adjakple, Great Neck, NY (US); Guodong Zhang, Woodbury, NY (US); Ravikumar Pragada, Warrington, PA (US); Ali Esswie, Montreal (CA)

(73) Assignee: InterDigital Patent Holdings, Inc., Wilmington, DE (US)

(21) Appl. No.: 18/864,710

(22) PCT Filed: Jun. 5, 2023
(86) PCT No.: PCT/US23/24434

§ 371 Date: Nov. 11, 2024

Related U.S. Application Data
(60) Provisional application No. 63/349,431, filed on Jun. 6, 2022.

(51) Int. Cl. H04W 72/51; H04W 52/02; H04W 72/25

(52) U.S. Cl. CPC H04W 72/51; H04W 52/0235; H04W 72/25

(57) ABSTRACT

Methods, apparatuses, and procedures for sidelink communications (e.g., using ultra-low power (ULP) components) are provided. For example, a wireless transmit/receive unit (WTRU) is configured to determine, based on ULP capability associated with target destination(s), information of a first transmission and a second transmission, and to transmit the first transmission including a first sidelink control information (SCI) associated with the first transmission, and the first SCI indicates resources for the second transmission and a ULP signal to be transmitted on the first transmission. The first transmission includes the ULP signal that indicates the target destination(s), the resources for the second transmission, and at least a first subset of a second SCI associated with the second transmission. The WTRU is further configured to transmit the second transmission including at least a second subset of the second SCI and sidelink payload data.

### CROSS-REFERENCE TO RELATED APPLICATION(S)

This application claims priority to and the benefit of U.S. Provisional Application No. 63/349,431 filed in the U.S. Patent and Trademark Office on Jun. 6, 2022, the entire contents of which being incorporated herein by reference as if fully set forth below in its entirety and for all applicable purposes.

### BACKGROUND

In some current implementations of sidelink (SL) communications, two procedures are related to SL devices monitoring of the resources on any of the configured resource pools (RPs). One is for channel sensing, to monitor the resource availability in the future and is used for SL devices that are configured to (potentially) transmit data. The other procedure is for SL data reception, where devices are configured with a reception resource pool on which they can receive data. In both procedures, devices may be required to perform constant or frequent monitoring and blind decoding of at least a PSCCH over their configured resource pools, and decoding of a second stage SCI in the PSSCH for the reception resource pools, which is energy consuming.

Current implementations of SL communications have no wake up signal design for sidelink, let alone some wake up signals based on ULP. It is possible to shut down the connection between a pair of users and let a device become IDLE/INACTIVE over its Uu link, and possibly use some wake up signal, but this would imply a very long latency as the device need to wake up the main radio for Uu connection, then re-establish connection to the user in Sidelink to be able to resume a communication. As such, enhanced or new procedures for Sidelink (SL) transmissions and receptions may be desired.

### SUMMARY

Embodiments disclosed herein generally relate to communication networks, wireless and/or wired. One or more embodiments disclosed herein are related to methods, apparatuses, and procedures for sidelink communications (e.g., using ultra-low power (ULP) receivers) in wireless communications.

For example, one or more embodiments disclosed herein are related to enhanced procedures that may include enabling a low power monitoring of a sidelink channel using a ULP air interface, design and selections of new sidelink formats and contents to embed ULP wakeup signals and ensure co-existence with legacy and non-ULP receivers, sidelink transmission of data and control via a ULP air interface, sidelink reception of data and control via a ULP receiver, and/or transmission and reception of second stage SCI content of another transmission via a ULP air interface.

In one embodiment, a method implemented by a wireless transmit/receive unit (WTRU) for wireless communications is provided. The method includes determining, based on ultra-low power (ULP) capability associated with one or more target destinations, information of a first transmission and a second transmission; transmitting, based on the information, the first transmission including 1) a first sidelink control information (SCI) associated with the first transmission, the first SCI indicates a set of resources for the second transmission and a ULP signal to be transmitted on the first transmission, and 2) the ULP signal indicating the one or more target destinations, the set of resources for the second transmission, and at least a first subset of a second SCI associated with the second transmission; and transmitting the second transmission including at least a second subset of the second SCI and sidelink payload data.

In one embodiment, a method implemented by a WTRU for wireless communications includes determining, based on ULP capability associated with one or more target destinations, information of a first transmission and a second transmission; transmitting, based on the information, the first transmission including 1) a first SCI associated with the first transmission, the first SCI indicates a set of resources for the second transmission and a ULP signal to be transmitted on the first transmission, and 2) the ULP signal indicating the one or more target destinations, the set of resources for the second transmission, and a second SCI associated with the second transmission; and transmitting the second transmission including sidelink payload data.

In another embodiment, a method implemented by a WTRU for wireless communications includes determining, determining, based on ULP capability associated with one or more target destinations, information of a first transmission and a second transmission; determining that the one or more target destinations are not capable of receiving a subset of SCI; transmitting, based on the information, the first transmission including a ULP signal indicating the one or more target destinations and the set of resources for the second transmission; and transmitting the second transmission including the SCI and sidelink payload data.

In one embodiment, a WTRU comprising circuitry, including a transmitter, a receiver, a processor, and memory, is configured to determine, based on ultra-low power (ULP) capability associated with one or more target destinations, information of a first transmission and a second transmission; to transmit, based on the information, the first transmission including 1) a first sidelink control information (SCI) associated with the first transmission, the first SCI indicates a set of resources for the second transmission and a ULP signal to be transmitted on the first transmission, and 2) the ULP signal indicating the one or more target destinations, the set of resources for the second transmission, and at least a first subset of a second SCI associated with the second transmission; and to transmit the second transmission including at least a second subset of the second SCI and sidelink payload data.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 are two block diagrams illustrating (a) a mixer-first energy detection (ED) based on-off keying (OOK) receiver and (b) a mixer-first ED based frequency-shift keying (FSK) receiver;

FIG. 3 is a block diagram illustrating an example of a ULP receiver with an all-passive RF front-end;

FIG. 4 is a diagram illustrating an example of ULP embedded reservation and retransmission(s), according to one or more embodiments;

FIG. 5 is a signal flowchart illustrating an example procedure performed by a WTRU having a ULP receiver receiving ULP embedded signal and retransmission(s), according to one or more embodiments;

FIG. 6 is a signal flowchart illustrating an example of a non-ULP WTRU receiving ULP embedded SL signaling when co-existence of ULP and non-ULP WTRUs, according to one or more embodiments;

FIG. 7 is a signal flowchart illustrating an example of a ULP embedded procedure with feedback of the transmitted ULP signal, according to one or more embodiments;

FIG. 8 are block diagrams illustrating an example of continuous SL ULP embedded transmissions: (a) a single sub-channel transmission, (b) a multiple sub-channel transmission with full resource allocation, and (c) a multiple sub-channel transmission with continuous resource allocation, according to one or more embodiments;

FIG. 9 are block diagrams illustrating an example of SL ULP embedded transmissions with demodulation reference signal(s) (DMRS): (a) a single sub-channel transmission with contiguous ULP resources allocation, (b) a multiple sub-channel transmission with contiguous ULP resources allocation, (c) a single sub-channel transmission with discontinuous resource allocation, and (d) a multiple sub-channel transmission with discontinuous resource allocation, according to one or more embodiments;

FIG. 10 are block diagrams illustrating examples of ULP-embedded SL frame structure(s) with reduced PSSCH, according to one or more embodiments;

FIG. 11 is a diagram illustrating an example of successive SL ULP-embedded transmission and reservation mechanism, according to one or more embodiments;

FIG. 12 is a diagram illustrating an example of consecutive SL ULP-embedded transmissions mechanism, according to one or more embodiments;

FIG. 13 is a diagram illustrating an example of a ULP-embedded SL slot structure with ULP signaling including a small data transmission, according to one or more embodiments;

FIG. 14 is a flowchart illustrating an example of a reception procedure of ULP SL small data transmission and selection of interface for monitoring, according to one or more embodiments;

FIG. 15 are diagrams illustrating an example of slot formats for an initial transmission (with ULP signaling) and one or more subsequent transmissions (with SL payload), according to one or more embodiments;

FIG. 16 is a signal flowchart illustrating an example of a reception procedure of ULP signaling embedded with partial second stage sidelink control information (SCI), according to one or more embodiments;

FIG. 17 includes three diagrams: (a) a first frame structure illustrating an example of an initial transmission including ULP signaling carries all the information of second stage SCI of one or more subsequent transmissions, (b) a second frame structure illustrating an example of a subsequent transmission with SL payload, and (c) a signal flowchart illustrating an example of SL transmissions, where the initial SL transmission includes ULP-embedded signaling carrying all the information of second stage SCI of subsequent transmission(s), according to one or more embodiments;

FIG. 18 includes two frame structures illustrating an example of a partial second stage SCI in ULP signaling and in a short PSSCH of an initial transmission, according to one or more embodiments;

FIG. 19 includes two frame structures illustrating an example of full second stage SCI in ULP signaling and in a short PSSCH of an initial transmission, according to one or more embodiments;

FIG. 20 is a signal flowchart illustrating an example of a non-ULP WTRU receiving second stage SCI in a reduced PSSCH transmission, according to one or more embodiments;

FIG. 21 is a flowchart illustrating an example decision process to select an SL ULP second stage SCI format, according to one or more embodiments;

FIG. 22 is a flowchart illustrating an example procedure implemented by a WTRU with ULP feedback for SL transmission, according to one or more embodiments;

FIG. 23 is a flowchart illustrating an example procedure implemented by a WTRU with ULP feedback for SL reception, according to one or more embodiments;

FIG. 24 is a flowchart illustrating an example procedure implemented by a WTRU sending second stage SCI of subsequent transmission(s) in an initial transmission, according to one or more embodiments;

FIG. 25 is a flowchart illustrating an example procedure implemented by a WTRU receiving second stage SCI of subsequent transmission(s) in an initial transmission, according to one or more embodiments;

FIG. 26 is a flowchart illustrating an example procedure implemented by a WTRU having a non-ULP receiver for SL reception, according to one or more embodiments;

FIG. 27 is a flowchart illustrating an example procedure implemented by a WTRU for transmitting SL ULP small data transmission(s), according to one or more embodiments;

FIG. 28 is a flowchart illustrating an example procedure implemented by a WTRU for receiving SL ULP small data transmission(s), according to one or more embodiments; and

FIG. 29 is a flowchart illustrating an example of an SL scheduling and transmission procedure having SL ULP signaling, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System, Networks, and Devices

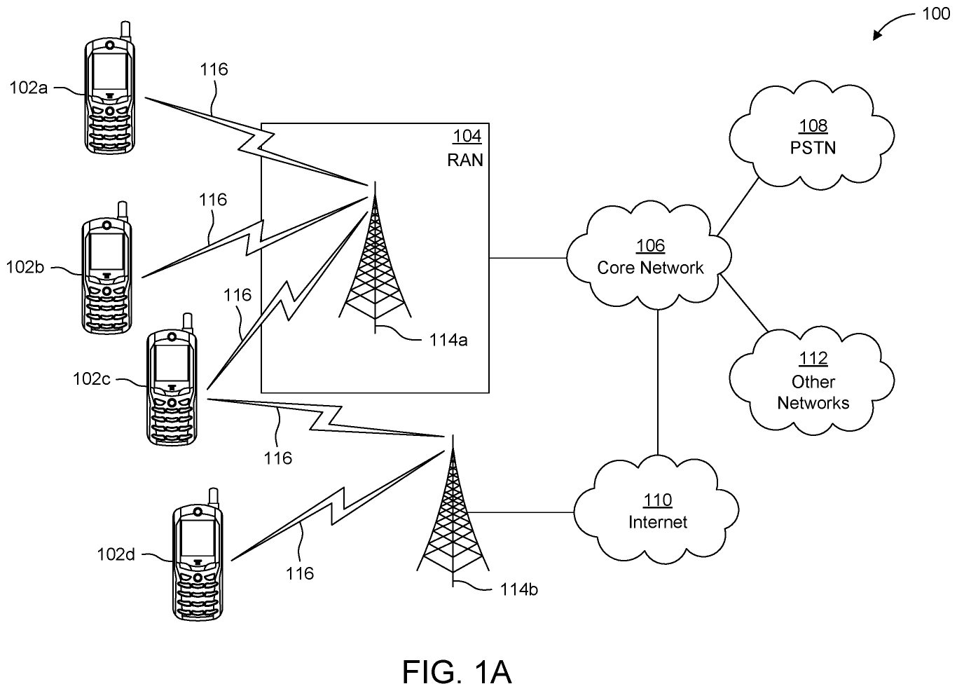

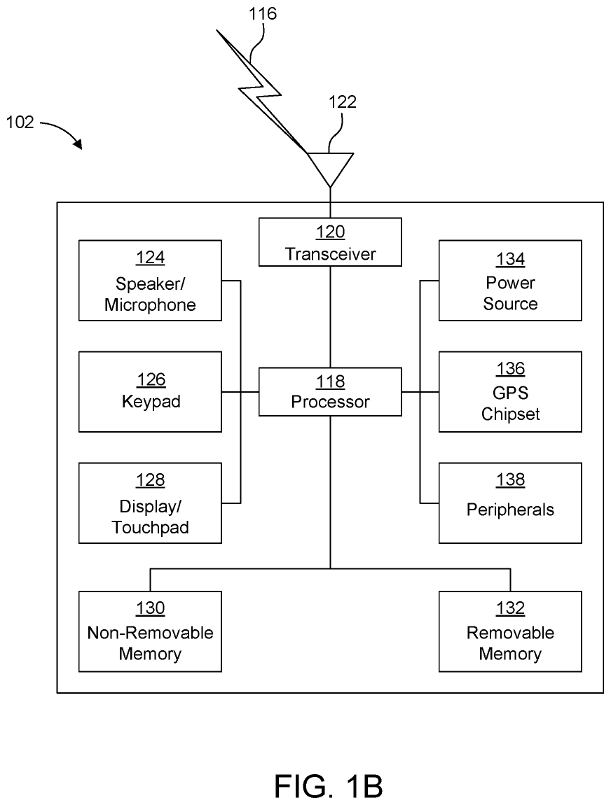

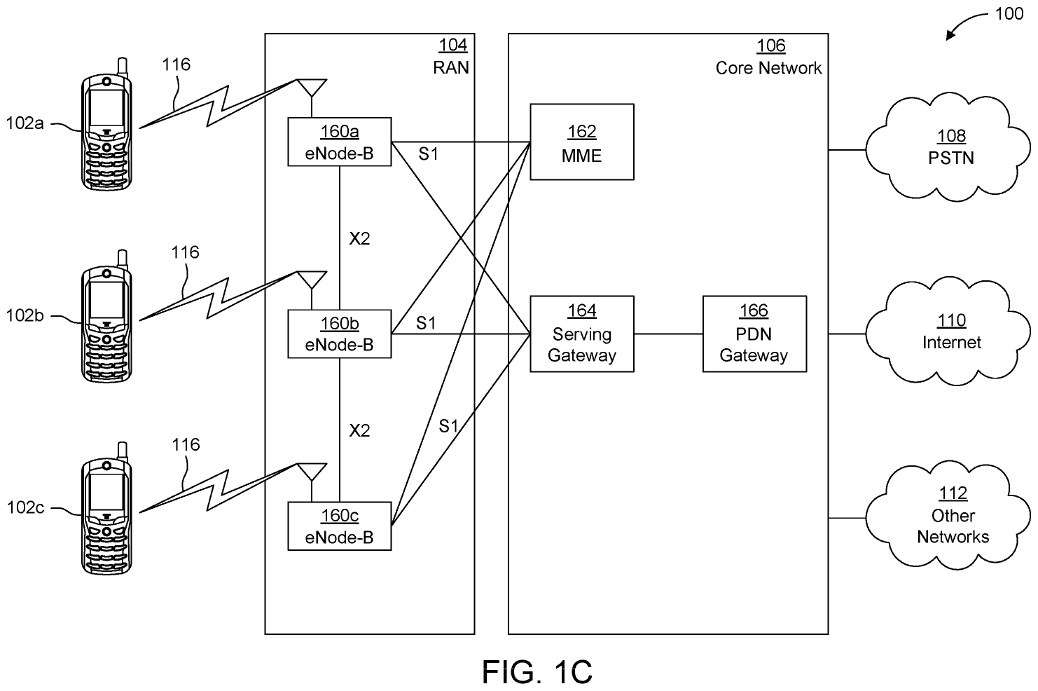

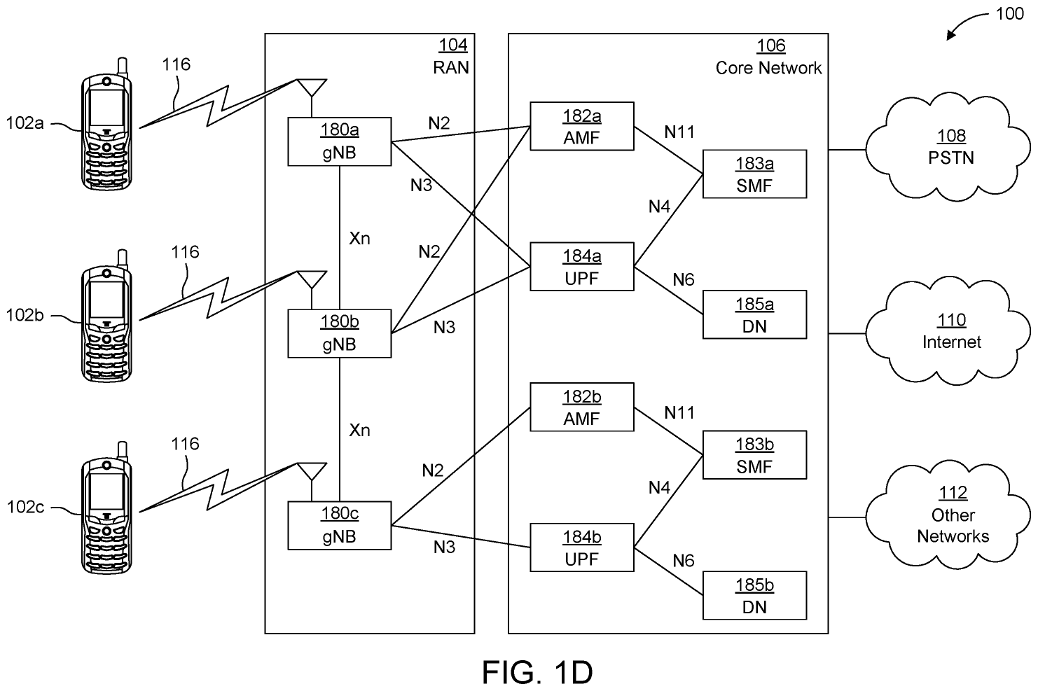

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like.

The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment.

As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Ultra-Low Power (ULP) Receivers

In state-of-the-art wireless technology such as cellular and WLAN, RF front-ends are usually a mix of passive and active components. For example, passive components include Rx antennas, Tx/Rx path switches and filters. These components require little if any power in order to function. On the other hand, active components require power in order to function. For example, the oscillator to tune to the carrier frequency, the low noise amplifier and the A/D converters in the Rx path are active components.

Advances in RF component design over the last years have made it possible to use a novel type of RF circuitry that can process received RF waveforms which are collected through the antenna front-end by the receiving device in an Ultra-Low Power (ULP) mode with minimal usage, or even absence, of an active power supply. For example, such a device may consider only passive RF components and harvest energy from the received RF waveform to run the necessary circuitry to process signals. Another increasingly popular approach is to use a mixer-first architecture, eliminate the need for an RF low noise amplifier (LNA), and focus on the development of passive RF components. Passive (or almost passive) ULP receivers use RF components such as cascading capacitors, zero-bias Schottky diodes or MEMS to implement the functionality required for voltage multipliers or rectifiers, charge pumps and signal detectors. It is worth considering that those ULP receivers can still operate in the antenna far-field and may support reasonable link budgets.

ULP receivers can perform basic signal detection such as correlation for a known signature waveform and/or reception of low data rate signals. They may also be put into energy harvesting mode by accumulating energy from the RF waveform entering the receiver front-end through the Rx antenna. Link budgets characteristic of small or medium area cellular base stations are supported. For example, ULP receivers can be used as wake-up radios to trigger device internal wake-up and signal interrupts following the detection of wake-up signaling which then prompts the main modem receiver using active RF components to start up.

The reduction in device power consumption are considerable when ULP receivers are used. A typical cellular 3G, 4G, or 5G modem transceiver may easily require up to a few hundred mWs in order to demodulate and process received signals during active reception (such as in RRC_CONNECTED mode). Power consumption scales with the number of RF front-end chains active on the device, the channel bandwidth used for reception and the received data rate. When the device is in RRC_IDLE mode with no data being received or transmitted, cellular radio power saving protocols such as IDRX ensure that the receiver only needs to be powered on a few times per second at most. Typically, the device then performs tasks such as measuring the received signal strength of the serving and/or neighbor cells for the purpose of cell (re-)selection procedures and reception of paging channels. In addition, the device performs AFC and channel estimation in support of coherent demodulation. Device power consumption when in RRC_IDLE is in the order of several mWs. In 3GPP NR Release 15, such as in eMTC and/or NB-loT devices, sequence detection circuitry for processing of in-band wake-up signals in RRC_IDLE mode may also be implemented in the form of a dedicated wake-up receiver. This allows to power down the A/D converters and significant parts of the digital baseband processor. However, several active components in the RF front-end such as low-noise amplifiers and oscillators are still used where the LNA power consumption is usually in the milliwatt range. On the other hand, ULP receivers can reduce device's power consumption in RRC_IDLE to about or below 1 mW by removing the RF LNA and having power consumption dominated by only the local oscillator.

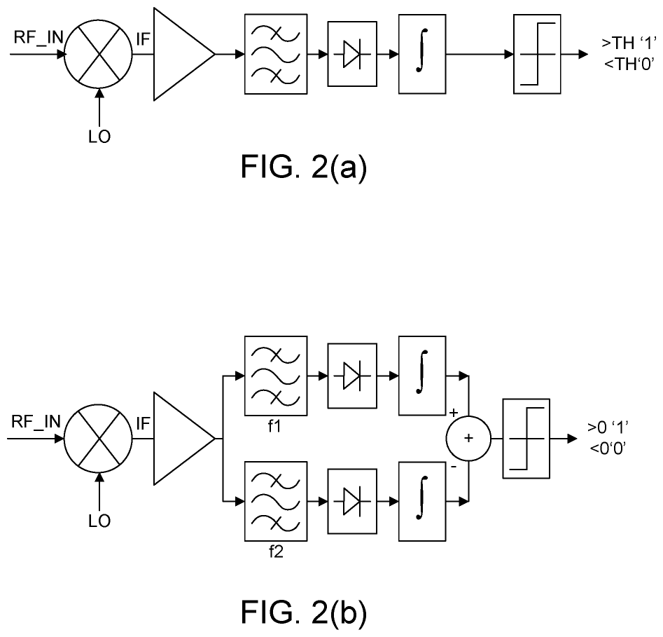

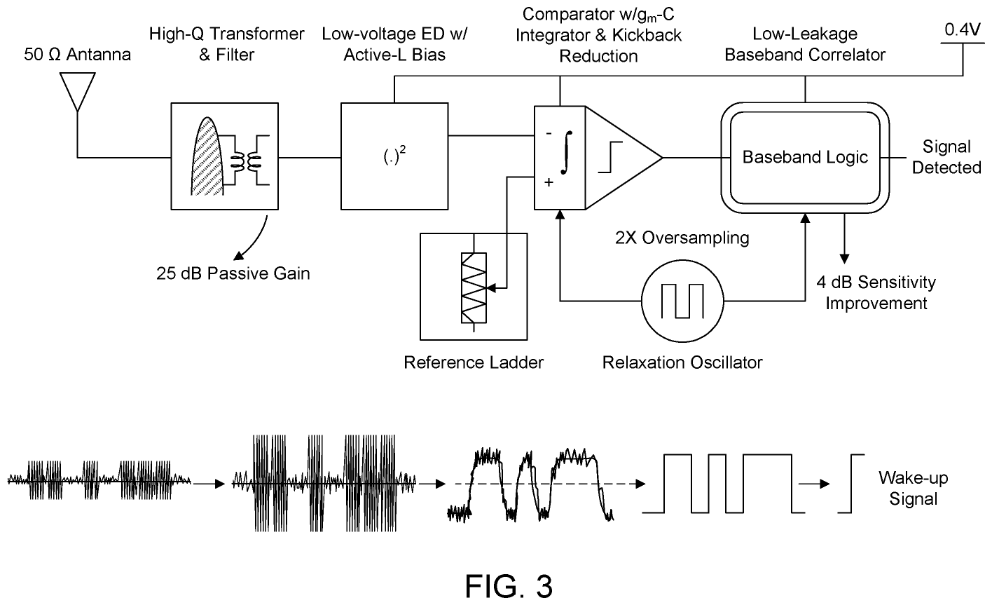

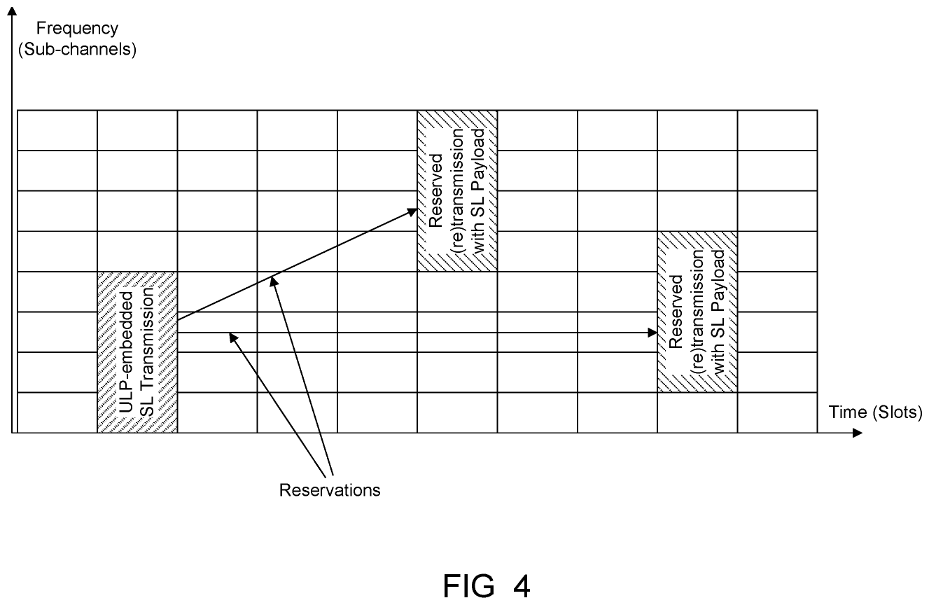

Two types of modulation schemes, On-Off Keying (OOK) and Frequency-Shift Keying (FSK), are the most commonly used in ULP receivers with OOK being the most attractive when designing ULP radios due to its simplicity. Simplified block diagrams for e.g., mixer-first energy detection (ED) based OOK and FSK radios are shown in FIG. 2. Whereas a simplified block diagram for a ULP receiver with an all-passive RF front-end is shown in FIG. 3.

### IDLE Mode Operations in 3GPP

In an example, WTRUs implementing either one or a combination of 2G, 3G, 4G, and/or 5G RATs perform PLMN selection, cell selection/re-selection and location registration procedures while in RRC_IDLE mode. Depending on capabilities, some devices may also support manual CSG selection or MBMS frequency prioritization in RRC_IDLE mode. 5G devices may support RNA updates and operation in RRC_INACTIVE state.

In an example, when a WTRU is switched on, a PLMN may be selected by the WTRU. For the selected PLMN, associated RAT(s) may be set. With cell selection, the WTRU searches for a suitable cell of the selected PLMN, chooses that cell to provide available services, and monitors its control channel. The WTRU may register its presence by means of a NAS registration procedure in the tracking area of the chosen cell.

While in RRC_IDLE, a WTRU may perform received signal strength measurements on serving and/or neighbor cells. If the WTRU finds a more suitable cell according to the cell reselection criteria, the WTRU reselects onto that cell and camps on it. If this new cell does not belong to at least one tracking area to which the WTRU is registered, location registration is performed. The WTRU may also search for higher priority PLMNs at regular time intervals and search for a suitable cell if another PLMN has been selected by its NAS.

If a WTRU loses coverage of the registered PLMN, either a new PLMN is selected automatically or an indication of available PLMNs is given to the user so that a manual selection can be performed. Various means of control exist for the network to prioritize cell selection onto certain RATs, to control the rate at which low, medium or high mobility WTRUs perform cell re-selection and to bar selected tracking areas from re-selection by WTRUs.

When the WTRU camps on a cell in RRC_IDLE state or in RRC_INACTIVE state, the WTRU may receive system information from the PLMN, and may establish an RRC connection or resume a suspended RRC connection. The WTRU may receive ETWS or CMAS notifications. Moreover, if the network needs to send a control message or deliver data to a registered WTRU, the network knows in most cases the set of tracking areas in which the WTRU is camped. A paging message can then be sent for the WTRU on the control channel(s) of all the cells in the corresponding set of areas. The WTRU may then receive the paging message and can respond.

### Sidelink (SL) Communications

In some implementations of NR Sidelink, two procedures are related to Sidelink (SL) devices monitoring of the resources on any of the configured resource pools (RPs). One is about channel sensing, to monitor the resource availability in the future and is used for SL devices that are configured to (potentially) transmit data. The other procedure is about SL data reception, where devices are configured with a RX resource pool on which they can receive data.

In the data reception procedure, SL devices are required to monitor the channel and blind decode the RX RP resources to find any potential Physical Sidelink Shared Channel (PSCCH), including the 1st stage Sidelink Control Information (SCI). Upon finding a valid 1st stage SCI, the device shall decode the 2nd stage SCI within the associated PSSCH, which is in the same slot—thus the device shall record and store the potential PSSCH symbols and decode if found a 1st stage SCI. The decoding of at least the 2nd stage SCI is mandatory in the RX resource pool as the entire destination ID of the transmission is in the 2nd stage SCI, and thus the receiving sidelink device only knows whether it is a destination of the transmission after decoding the 2nd stage SCI.

In the channel sensing/resource allocation procedure, SL devices are configured with TX resource pools, where they can schedule transmissions. Mainly for Mode 2 scheduling, they should monitor, and blind decode PSCCH for 1st stage SCIs and the resource reservations included in there, as well as perform energy measurement over the PSSCH. NR Release 17 introduced some limitations of sensing for power efficiency but still relies on some sort of partial sensing or loss of information (due to missed transmissions). The partial sensing in NR Sidelink is similar to the one in LTE, where a device is required to monitor only selected periodicities, with added monitoring for the aperiodic reservations.

In both procedures, devices may be required to perform constant or frequent monitoring and blind decoding of at least the PSCCH over their configured resource pools, and decoding of the 2nd stage SCI in the PSSCH for RX resource pools, which is energy consuming.

Currently, there is also no wake up signal design for Sidelink, let alone some wake up signals based on ULP. It is possible to shut down the connection between a pair of users and let a device become IDLE/INACTIVE over its Uu link, and possibly use some wake up signal, but this would imply a very long latency as the device need to wake up the main radio for Uu connection, then re-establish connection to the user in Sidelink to be able to resume a communication.

As such, enhanced procedures for Sidelink (SL) transmissions and receptions may be desired. For example: reducing the energy consumption of monitoring and receiving 1st stage SCI and 2nd stage SCI for SL devices configured to receive transmissions, while avoiding severe latency and the disconnection and reconnection procedures of a SL device with infrequent data reception; ensuring coexistence between proposed solution and legacy or non-ULP capable devices, so that other devices can still perform a good data reception and/or monitoring for their channel sensing; and/or reducing the overhead of 2nd stage SCI transmissions.

### Representative Procedure for Sidelink Signal Reception

Various embodiments disclosed herein are related to Sidelink data receptions. Methods and procedures are provided that one of the devices (e.g., a WTRU) with a ULP receiver, that can turn off its regular SL radio receiver monitoring by its main radio to save energy, while monitoring the channel with the ULP receiver for potential reserved transmissions.

In some examples, the ULP receiver is in a SL device configured for SL reception and not for channel sensing for resource selection.

In various embodiments, devices (e.g., WTRUs) are configured to perform in-band Sidelink ULP transmission, where the ULP signals may be transmitted over SL resource pools that are shared with devices (e.g., WTRUs) that may not be equipped with ULP receivers.

Note that it is also applicable to scenarios where a set of resources is configured to be monitored only ULP receivers, so that it is separately multiplexed in time and/or frequency domain from regular SL transmissions. These resources separation can be configured using, for example, different resource pool, different BWP or even different bands.

In some examples, the NR SL framework and frame structure may be reused to ensure backwards compatibility and inter-operability with other devices, and to be able to operate within the regular SL channels (Bandwidth Part (BWP) and/or Resource Pool (RP)).

A Sidelink user transmitting to a WTRU device while, e.g., the WTRU's main receiver is in sleep mode and ULP receiver is in use for channel monitoring, shall first transmit a signal suitable for the ULP receiver (e.g., a ULP signal), so that the WTRU wakes the main receiver up for receiving the actual data payload.

To save the energy consumption of the SL device, we may offload the transmission of any of the 1st and the 2nd stage SCI of regular SL devices, needed to receive transmissions, to a ULP air interface (e.g., using a ULP receiver). The ULP receiver has a very low power consumption but may support limited data-rate, and may be used to acts as a wake-up receiver for SL.

To ensure the co-existence of the ULP signaling and reservation of retransmission mechanism with other SL devices, the ULP signals are embedded within the legacy SL slot format, keeping the PSCCH (and possibly DMRS) so that other users can perform the channel sensing or correct blind decoding.

Keeping the NR SL frame structure allows to reserve resources for retransmissions, which can be used to schedule the actual data transmission using the main radio receiver, and other users performing the channel sensing can take into account this reservation in their resource selection procedure to avoid (e.g., reduce) transmission collisions.

Some extensions of current implementations or procedures intend to increase the inter-operability of the embedded ULP signaling and optimize the use of resource to reduce the signaling overhead.

To reduce the signaling overhead of the 2nd stage SCI (in the subsequent transmission), in an example, the ULP signaling (e.g., in the initial transmission) may carry some of the 2nd stage SCI content in anticipation of the subsequent transmission. The content depends on the ULP supported data rate and signaling capabilities and a new sub-format of 2nd stage SCI can be defined. Having already transmitted parts of the 2nd stage SCI using the ULP signal, the subsequent transmission may only transmit the remaining parts, to reduce the overhead in the retransmission. The WTRU with ULP receiver may then combine configuration/information received from both interfaces, and use it to decode the data.

To ensure a co-existence with other users, and in particular to allow transmissions to a mixed group of ULP and non-ULP destination (e.g., groupcast), a device (e.g., a WTRU) or network may duplicate the parts of 2nd stage SCI transmitted over ULP into a sub-format of 2nd stage SCI transmitted over the initial transmission. Both ULP and non-ULP devices can then receive the entire content of the 2nd stage SCI, over both transmissions to decode the payload.

In various embodiments, a “non-ULP legacy device” is a device that is capable of performing 3GPP NR Sidelink transmissions and receptions as intended by the specification, but it is not aware of the changes or specification aspects of ULP signals (e.g., a device implementing the specification up to the Release prior to the introduction of ULP signals for SL). It is also not capable of receiving/transmitting ULP signals.

In various embodiments, a “non-ULP non-legacy device” is a device that implements the 3GPP NR Sidelink specification and is capable of SL transmissions and receptions. It does not have a ULP receiver (or at least that the ULP receiver is not active for the time considered) but it implements and follows the specification on how to handle the receptions of signaling related to ULP co-existence. It may or may not be capable of transmitting ULP signals.

In various embodiments, a “ULP capable device” is a device that includes a ULP receiver in addition with its main radio transceiver, and is compatible with the 3GPP NR specification for handling the ULP signal reception.

Representative Procedure for in-Band ULP Signaling in Sidelink Transmissions

### Representative Procedure for Embedding ULP Signal and Reservation of (Re)Transmissions

### Leveraging (Re)Transmissions and Reservation Scheme for ULP

In one embodiment, to accommodate the wake-up/ULP signal with the existing NR Sidelink framework, the enhanced methods/procedures may include embedding the ULP signal into the resources of the PSSCH, and/or leveraging the retransmission reservation scheme to allow the transmission of SL data to happen in two steps. First, an initial SL transmission carries the ULP embedded signaling, to wake-up the WTRU with ULP receiver, and the regular PSCCH with 1st stage SCI, to reserve resources for retransmissions and to allow co-existence with other devices performing channel sensing or reception. Second, the subsequent transmission(s), reserved by the initial transmission, carry the actual transmission payload for the destination that has been woken up.

The RP can be configured to allow the reservation of one or two blocks of resources in the future for retransmissions. This reservation is announced in the initial transmission, within the 1st stage SCI, i.e., within the PSCCH. Note that in NR SL, the resources reserved for retransmissions may be selected within any of the next 32 logical slots of the resource pool and may be selected anywhere in the frequency domain of the resource pool. The reserved resources are determined by the time and frequency resource assignment indications within the 1st Stage SCI.

As illustrated in FIG. 3, an initial transmission with a frequency width of 4 subchannels is performed in the SL resource pool, which contains the ULP indication (described hereafter). The initial transmission provides the reservation of resources for future (re-)transmissions using the 1st stage SCI indications in PSCCH. The reservation mechanism is the same as the one in NR SL to ensure coexistence with nearby users. The retransmissions are regular Sidelink transmissions that the destination can receive using its main SL radio receiver.

The combination of regular SL and ULP signals within a transmission allows this invention to ensure the co-existence between ULP and non-ULP devices (Legacy or non-legacy), when sharing a common BWP/RP.

When monitoring the ULP signals, the ULP-receiver device is not able to read the PSCCH, and so is not able to determine the scheduled reservation for the retransmissions. This scheduling information (time and frequency resource assignment) can however be carried in the ULP signaling, jointly with the destination of the wake-up signal (see next sections).

Alternatively, it is also possible not to send the scheduling of the retransmission information, but then the ULP WTRU has to re-activate the monitoring of the regular SL channel within a maximum (pre)configured time delay and resume the blind decoding on all the slots of its resource pool, which is more energy consuming than knowing when the user should wake up for the next transmission.

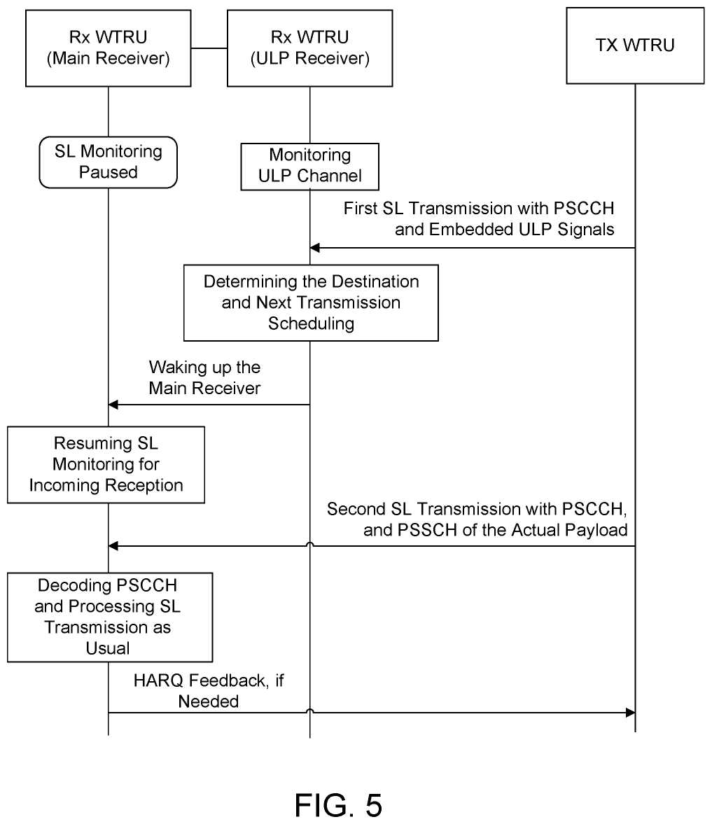

As illustrated in FIG. 5, the WTRU device with a ULP-receiver may be configured to monitor ULP signals and perform in-band monitoring while the regular radio receiver is turned off or in deep sleep, i.e., not monitoring the sidelink channel. Upon reception of the ULP signal targeting the WTRU, the WTRU decodes the ULP signal and determines if it is the intended recipient(s) of the signal and of the scheduled reserved transmission. If it is a destination, the ULP receiver shall inform and wake up the main sidelink receiver and the WTRU device prepares itself to receive the transmission payload over the retransmission resources. In subsequent (re)transmissions, the transmission uses the regular Sidelink format, with both PSCCH and PSSCH that includes the two SCIs and the data payload to be decoded. If configured to do so, the WTRU can then perform a HARQ feedback to the transmitter.

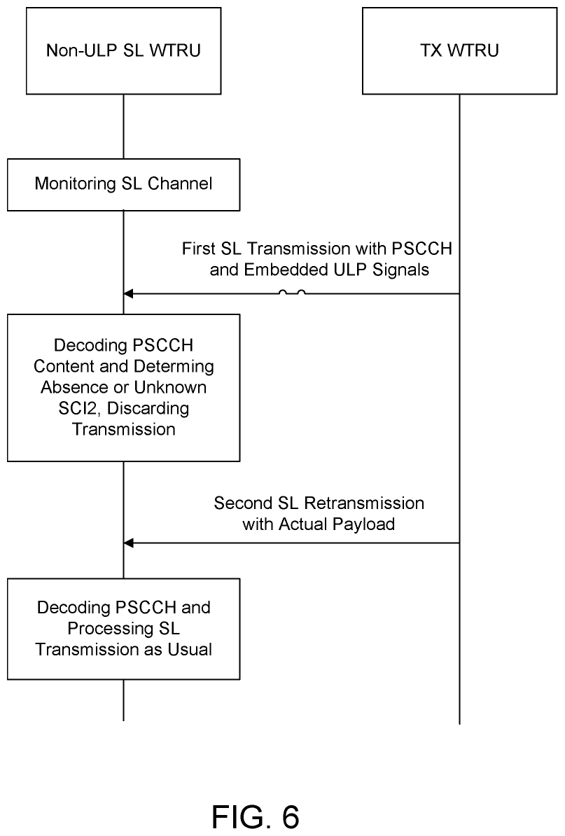

As illustrated in FIG. 6, a non-ULP user and/or legacy device, configured to monitor SL over the same or overlapping resource pools, will decode the 1st stage SCI in the PSCCH as they usually do, and get the scheduling information of the reserved resources and so they can take them into account in the resource selection procedure. Upon decoding the indication of ULP embedded signaling, absence of 2nd stage SCI or unknown 2nd stage SCI, the non-ULP WTRU may ignore and drop the content in the remaining resources of the transmission. Retransmissions are typical NR SL transmissions and thus can be treated normally by these devices. They will not, however be compatible to read the ULP signals, which are not intended for them, and can discard the received signals but can still, if required by other procedures such as channel sensing, perform measurements over the “PSSCH” or DMRS symbols.

### Ulp Reception Failure Detection and Handling

In the simplified scheme illustrated in FIG. 5, upon detecting the ULP wake-up signal intended for itself, the ULP receiver will trigger the main radio receiver chain to monitor the channel and receive the subsequent transmission. But in case of failure to receive the ULP signals properly—and if nothing else is done—the main radio will not wake up in time to receive the retransmission.

In one embodiment, the failure detection at the TX user side is managed by the HARQ feedback of the (re)transmission. As illustrated in FIG. 5, the RX WTRU performs HARQ feedback after reception of the payload transmission if the configuration of the SL transmission requires it. The HARQ feedback is enabled/disabled with a bit flag in the 2nd stage SCI and so is transmission specific.

In Unicast transmissions and in some groupcast transmissions, the HARQ uses ACK/NACK feedbacks (absence of feedback reception is a Discontinuous Transmission (DTX)). At the TX side, after the transmission of the payload, reception of one of the following from the receiver:
An ACK indicates that both ULP wakeup call and SL payload transmission have been successful, and that it can proceed with the next transmissions as usual, if any;
A NACK indicates that the ULP signal, the PSCCH and 2nd stage SCI reception were successful, but the payload was not. In this case, a regular SL retransmission can be performed, resuming regular HARQ process and retransmission management; and/or
In the case where neither ACK or NACK is received (a DTX), the TX user knows that at least the 2nd stage SCI was not received but doesn't know whether the ULP signal was received and hence whether the main SL radio is activated.

In an example, to mitigate this, when the ULP signal was correctly detected but not the 2nd stage SCI afterwards, the RX sends a status update to the TX, via a MAC-level (e.g. Sidelink MAC CE), PHY-lever signaling (e.g. for ULP dynamic (de)activation), or a RRC reconnection/reconfiguration. This way, the TX user knows that the RX already woke up its main radio, and then the TX user can retransmit using the regular SL transmissions. If no indication is received by the TX user within a configured period of time, it shall assume that the RX user did not receive the ULP signaling, and shall retry to transmit the ULP signaling, wait for a duty-cycled main SL monitoring, or inform the network about the ULP failure.

In groupcast transmissions using NACK only HARQ feedback (absence of feedback interpreted as an ACK), the reception of a NACK would imply that the ULP was detected successfully, the PSCCH and the 2nd stage SCI decoded successfully also, but the payload was not. In this case, a regular SL retransmission can be performed, resuming regular HARQ process and retransmission management. The absence of reply from the ULP user is ambiguous and could either mean that the ULP and SL were successful, that the ULP was successful but not the SL transmission while being too far from the TX (as there is a distance limit to reply to HARQ feedback in NACK only SL groupcasts), or that the ULP was not successful, and the main SL is not awakened. If the RX user received the ULP signal, but the user doesn't have a NACK to transmit within a configured period of time, it can send to the TX user an indication of its status, i.e. that the main SL radio is activated, using PHY-level or MAC level signaling. That will confirm to the TX user the successful reception of ULP signaling and that it can perform the following transmissions regularly.

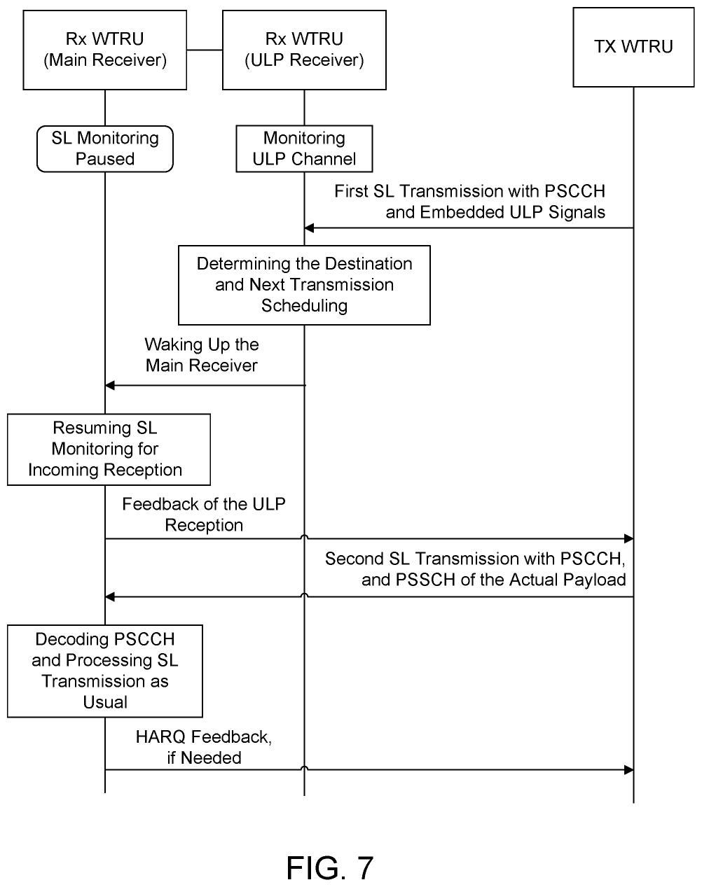

In one embodiment, as illustrated in FIG. 7, we propose that the WTRU with ULP receiver sends a feedback transmission to acknowledge the reception of the ULP signals. Upon reception of the ULP signal that targets the ULP receiver, the WTRU wakes the main SL radio up and uses the Physical Sidelink Feedback Channel (PSFCH) associated with the ULP embedded transmission to report the reception. The feedback can be a preconfigured method or enabled through an indication in the ULP signaling.
An ACK implies the correct reception of intended ULP signals;
A NACK implies that the ULP signal was not correctly (or not completely) detected/decoded, but the UE determined that it is a destination of the ULP signaling. One possible scenario is if the ULP signaling contains the destination ID and other contents (e.g. scheduling information) sent as two successive signals and only the destination ID was correctly received; another scenario would be if the ULP signal itself implicitly helps to determine the destination (e.g. if the scheduling of the ULP signaling maps to specific IDs) but the content is not decoded; and/or
DTX implies that the ULP signaling was not received.

Upon reception of an ACK, the TX may proceed with the (re)transmissions targeting the main SL radio receiver. Upon reception of a NACK, the TX may proceed with the (re)transmission targeting the main SL radio receiver but shall assume that only the ULP destination ID was correctly received. In case of DTX, the TX user shall proceed with a fallback mechanism, for example, it will reinitiate the ULP wake up signal or wait for a duty-cycled monitoring of the main SL receiver or reports the failure to gNB.

As an alternative, instead of reporting using the PSFCH, the RX WTRU can send a command/control information to the TX WTRU indicating the resuming of regular SL monitoring that can include additional configurations (e.g., similar to a SL RRC Reconfiguration). This allows more information but requires a regular SL transmission, i.e., with resource selection, transmission preparation etc. that adds significant latency in the process.

As mentioned above, it is possible for the WTRU with the ULP receiver to be configured to perform a “duty-cycle” monitoring of the SL channel with its main radio receiver. This can be enabled to recover in case of ULP failure (e.g., scenarios where ULP signals are out of range). The duty-cycling of the main radio receiver is configured as part of the (pre)configuration either at the RP level or SL RRC configuration, which can be configured for example as a periodic monitoring in time (e.g., every 100 ms) or periodic in a number of logical slots from the RP (e.g., one slot for every 32 slots). This monitoring of the SL channel is a fallback mechanism that can be used by a TX user that attempting to perform a ULP wake up signal without reception of ACK/NACK feedback.

As an alternative/complementary fallback mechanism, the TX user that didn't receive any feedback or status update from the ULP device within a configured time can report to the network of the failure and the network can proceed to wake-up the ULP device, either by dedicated ULP or Uu signaling (e.g., paging).

### Ulp Embedding and Resource Mapping

In an initial transmission of the ULP-embedded transmission scheme, the Sidelink transmitter sends a new Sidelink format, based on the Rel-16/17 frame structure and slot format.

The proposed format keeps the NR SL PSCCH, that still also includes a 1st stage SCI. The AGC and guard symbols are also kept for protection of the signals and helping the receivers' adaptations between adjacent transmissions from different users. However, the resources as indicated in the 1st stage SCI (frequency assignment) that are used for the PSSCH in regular SL transmissions are replaced and allocated to the ULP signal transmission.

Note that the resources allocated for the ULP signaling are not necessarily all used for the ULP signal transmission itself and can also include potential guard time in time domain and/or guard bands in frequency domain, depending on the design and requirements of the ULP signals themselves. For example, if the designed ULP signal occupies a limited or fixed bandwidth but the SL frequency resource is larger than that, then the “empty” frequency resources adjacent to the ULP signal can be used as guard bands in the ULP resource allocation.

The NR SL design is made so that one transmission can span over any number of sub-channels (which is a configured multiple of resource blocks for a given resource pool), in a resource pool. Also, for blind-decoding purposes, the PSCCH has a size of one sub-channel and over 2 or 3 symbols fixed (also configured per resource pool). Thus, if the transmission is scheduled over multiple sub-channels, the frequency resources adjacent in the frequency domain to the PSCCH, on the same symbols, are generally used for PSSCH (or DMRS).

There exist several variants on how to map the physical resources for the ULP signals. The configuration of which option(s) and format(s) of ULP can be used is (pre)configured, for example, as part of the SL RRC Connection/Reconfiguration procedure, RRC Connection/reconfiguration procedure, or via SIB indications.

In one embodiment, the resources allocated to the ULP signaling represent all the resources of the scheduled SL slot in the PSCCH, except for the PSCCH itself and the symbols for AGC and Guard. This means that the DMRS symbols are not transmitted. Note that the DMRS associated to PSSCH is not needed to decode the PSCCH, as there is already a DMRS associated with PSCCH, within the PSCCH resources.

Note that in this case, the measurement of RSRP for channel sensing should not be based on PSSCH-RSRP, and the resource pool should be configured to let users perform PSCCH-RSRP. Alternatively, non-ULP but non-legacy devices may be able to utilize the ULP signal to perform signal strength measurements, and may further use a configured mapping between the ULP-RSRP measurement and the corresponding regular PSSCH-RSRP to mitigate a potential difference in the signaling power transmitted for regular PSSCH and ULP signals.

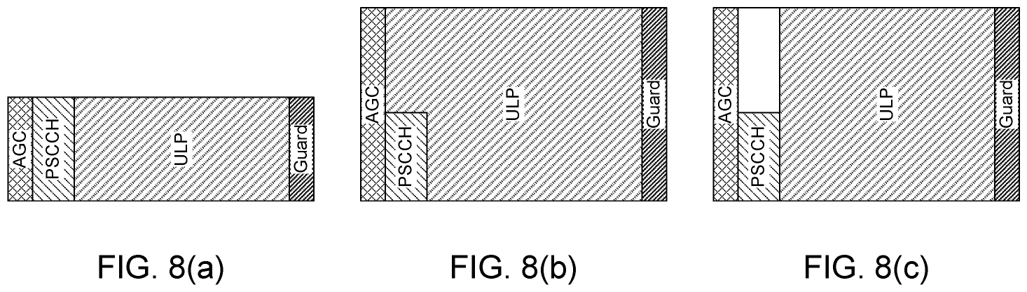

This embodiment enables the maximization of the resource's usage for the ULP signals, with a continuous block of resources in the time domain. Three alternatives are illustrated in FIG. 8.

In the case of a single sub-channel transmission (FIG. 8(a)), the resources allocated for the ULP signaling is a consistent block of resources in the frequency and time domain, which can be beneficial for the ULP signal design and ease the transmission and detection of the ULP signal.

In the case of a transmission scheduled over multiple sub-channels (FIGS. 8(b) and (c)), some resources are adjacent to the PSCCH in the frequency domain, over the same time symbols. If the ULP signal design supports the transmission over such block of resources, as illustrated in FIG. 8(b), the ULP embedded structure is configured to enable the allocation of these resources for the ULP signal. Otherwise, the resources for ULP can be restricted to the block of “squared” time-frequency resources over the symbols after the PSCCH, as illustrated in FIG. 8(c).

Note that the AGC symbols, that is not required to detect/decode the ULP, can be restricted in the frequency domain to the sub-channel of the PSCCH, so that other users can anticipate the received power over the PSCCH only.

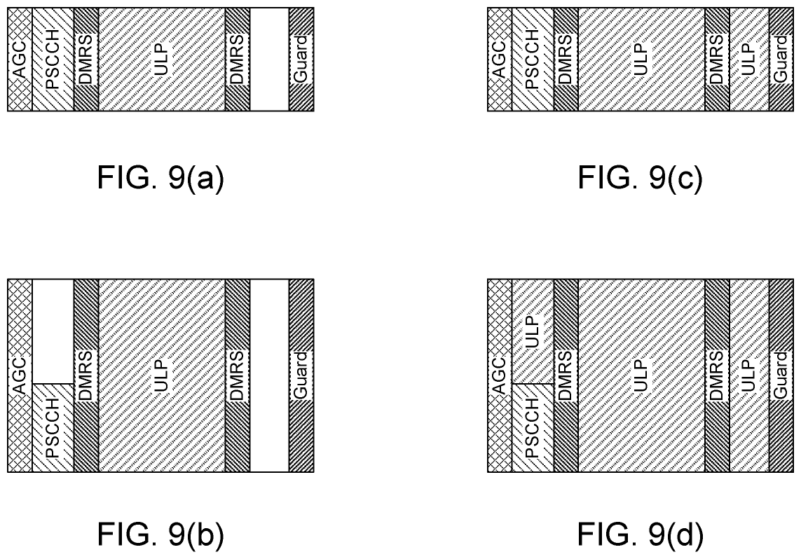

In another embodiment (see examples in FIG. 9), the resources allocated to the ULP signaling correspond to the resources of the scheduled SL slot in the PSCCH, except for the PSCCH itself, and the symbols for AGC and Guard, and DMRS. The Sidelink transmissions of other users are used for measurements, e.g., during the sensing, and the RP can be configured to use PSSCH-RSRP as a metric to determine whether the resource is available or not, e.g., can be reused or not. Thus, it could be useful for other users to keep a recognizable signal (e.g., the DMRS) for measurements. When the DMRS symbols are not transmitted adjacently to the first or last symbols of the slot transmission, they create a discontinuity with the ULP resources.

In the case where the ULP signals do not support the discontinuity, the ULP signaling resource allocation spans over the resource in between the remaining SL signals/channels, as illustrated in FIGS. 9(a) and (b), for single and multiple sub-channel cases, respectively. In the case where the ULP signals support non-contiguous transmissions, the resources allocated to the ULP signaling can span over all the resources “freed” by the absence of PSSCH. This is illustrated in FIG. 9(c) for single sub-channel transmission and FIG. 9(d) for multi-sub-channel transmissions.

Note also that similar options can be derived in the case where PSFCH is required in the slot, and so where the last symbols (guard, AGC, PSFCH and guard symbols) are not allocated for the ULP signaling. Depending on the ULP signal design and data rate available, it might be easier to avoid such slots to maximize the ULP resources.

Alternative SL Structure with PSCCH and PSSCH for ULP Embedded Transmission

An alternative format for sidelink transmission with ULP-embedded signal is that the initial transmission includes the ULP signaling, a PSCCH with the 1st stage SCI, but also a PSSCH. The PSSCH is reduced in size is not intended to carry payload in this context but carries, a 2nd stage SCI. To ensure backward compatibility, the PSSCH carrying the 2nd stage SCI should be placed first, before the ULP resources, e.g., where the 2nd stage SCI would have been in a regular SL transmission.

This way, non-ULP users monitoring the channel can also decode the information of the 2nd stage SCI and, for example, know the destination and source of the transmissions which can be helpful to know if the non-ULP user is part of the destination, e.g., as a group destination. The source and destination information can also be used to improve the resource selection (e.g., avoid selecting resources with duplexing conflicts for the destination or source of the transmission) or in the case of cooperation/coordination between users.

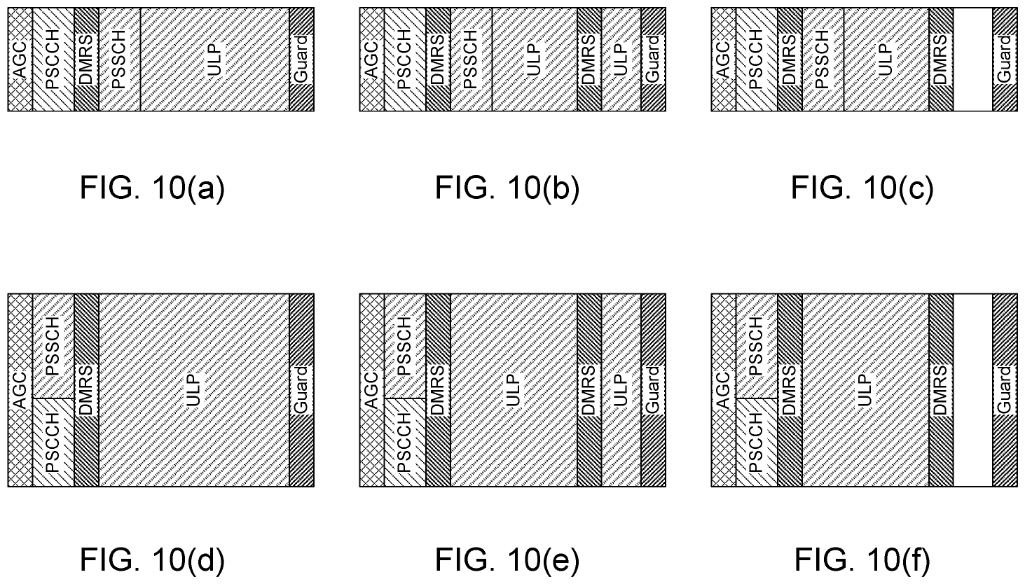

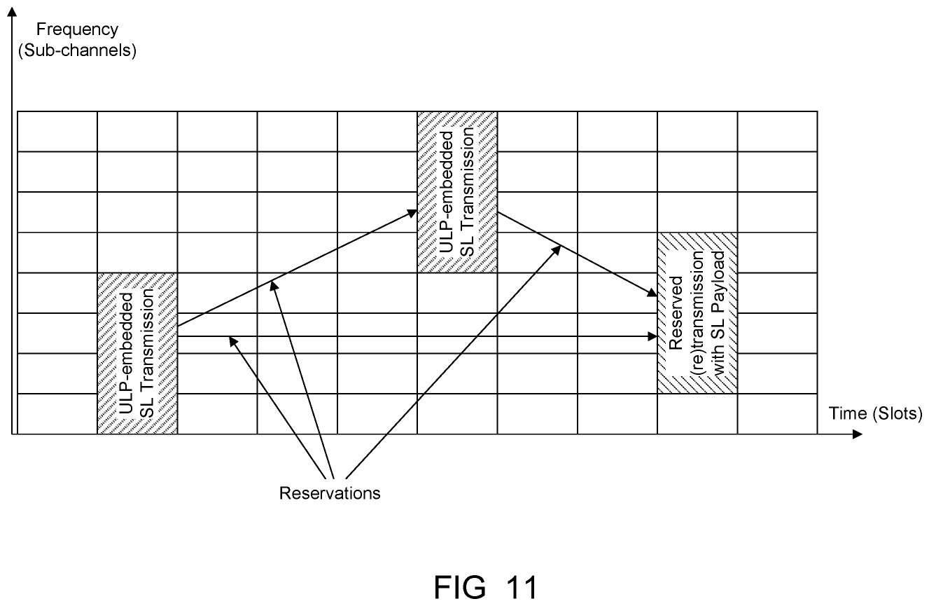

As illustrated in FIG. 10, several formats can be defined, that can be used depending on the scheduling. Having a PSSCH to decode, it is necessary to keep some PSSCH-DMRS symbol(s). In NR Release 16 and 17, there is at least 2 symbols for DMRS (e.g., 3GPP TS 38.211 sec. 8.4.1.1.2), illustrated in the example of 2 DMRS symbols in FIG. 10(b)(c)(e)(f). In these cases, embodiments and options as in the case without PSSCH can also apply. For instance, the FIG. 10(b) illustrates the example of single subchannel transmission, with a PSSCH and with discontinuous ULP resources; FIG. 10(c) illustrates the example of single subchannel transmission, with a PSSCH and with a contiguous block of ULP resources; FIG. 10(e) illustrates the example of multiple subchannel transmission, with a PSSCH and with non-contiguous ULP resources; FIG. 10(f) illustrates the example of multiple subchannel transmission, with a PSSCH and with contiguous ULP resource. Note that in the cases illustrated in FIG. 10(e)(f). the PSSCH resources are not restricted to be adjacent to the PSCCH resources, depending on the size of the PSSCH, the slot format and the transport format.

It is proposed that, since the PSSCH is here limited to a 2nd stage SCI, only one DMRS symbol can be used for decoding the PSSCH, hence keeping more resources for the ULP signaling, as illustrated in FIGS. 10(a) and (d), for single and multiple subchannel transmissions, respectively. This new DMRS pattern needs to be added in the sl-PSSCH-DMRS-TimePatternList configuration that includes the list of DMRS patterns. Alternatively, the legacy time pattern list can be kept as it is for better backwards compatibility but only the first DMRS symbol is actually used when the transmission is not carrying the payload.

Duty-cycled ULP monitoring and slots grouping for ULP-embedding transmission

To further reduce the need for processing and energy consumption for the ULP device, we propose that ULP embedded transmissions occasions can be grouped in specific time and/or frequency resources of the Resource Pool, so that it will limits the occasions of transmitting the new ULP SL format on the same resources used for legacy and/or non-ULP devices. This can take the form of a duty-cycled configuration over the used resource pool. This is a trade-off between latency and energy saving and can be configured for the RP or the ULP user, to consider the applications requirements.

The Resource Pool can be configured in order to re-group the ULP receiver devices over specific time slots of the SL BWP. In the case where the resources for ULP signaling are not dedicated to the ULP signals (i.e. they can be used for either ULP or regular SL transmissions), the processing burden depends on the grouping of the resources. If re-grouped over the same time slots, the re-grouped ULP devices will receive more ULP signals and may attempt to decode and process them until determining they are not the destination, i.e., a false alarm situation, but the non-ULP devices will be ensured not to carry the burden of receiving unnecessary transmissions over the other slots. If the ULP devices are configured so that their ULP signaling are not using the same slots, then they will avoid the false alarm issue and optimize the battery life of the ULP device, while multiplying the occasions for unnecessary transmission decoding for non-ULP devices.

In the case where the resources for the ULP signaling are configured to be only monitored by ULP receivers, non-ULP users may skip the decoding over these resources and save processing and energy consumption as well.

There are three methods to configure the resource pools for ULP-embedded SL and SL:

First, separated resource pool and switching. The resource pools are separated by configuration and independently configured. The control (e.g., SCI or DCI) enables the switch between the RPs to be activated at a time. The RP for the ULP-embedded SL transmissions can be rather sparse to perform a duty-cycled monitoring. The switching can also be considered implicitly done when the ULP monitoring is (de)activated.

Second, ULP as a subset of regular RX RP. The resource pool for the ULP monitoring is a subset of the active SL RP used by the user when switching to ULP monitoring. The subset can be configured (e.g., by SL RRC) for each RP or globally as a scheme for any RP. This way, no specific dynamic signaling is needed to (de)activate the ULP monitoring RP.

Third, separated resource pool but both “active” for each interface. The resource pools are separated by configuration and independently configured. In contrast with NR SL (up to Rel. 17) that only allows a single RP to be active at a time for a user, we propose that both RPs to be active, i.e., one for each interface. The TX devices will however select the RP to transmit based on the ULP monitoring state of the RX device.

### Ulp Signal Indications and 1st Stage SCI Formats

The 1st stage SCI carries important information for scheduling reservations, and how to interpret the 2nd stage SCI. Sidelink users in the RP perform blind decoding of the potential PSCCHs for 1st stage SCIs. Upon successful decoding of a 1st stage SCI, users may attempt to decode the corresponding PSSCH (2nd stage SCI and data payload), based on information of the 1st stage SCI such as transmission size, MCS, DMRS pattern, 2nd stage format. Therefore, having a new structure to embed the ULP signal, it is provided modifications to the 1st stage SCI so that users monitoring the channel understand the on-going transmission.

Upon reception of a 1st stage SCI indicating that the PSSCH content is actually an ULP signal, the users not targeted by the transmission can ignore the PSSCH. Note that they still can perform measurements if required.

Several options/embodiments are possible for the indication of ULP content itself:

Using the Reserved values in the 1st stage SCI. Using a one-bit indication as a ULP signal indication can be understood by non-legacy users, while it is considered as a reserved field (and thus ignored) by legacy users. To enable this option, a new 1st stage SCI needs to be defined, that adds the ULP indication to the regular 1st stage SCI (SCI format 1-A). Either through a new format with a specific name, say, SCI format 1-B or equivalent; or through a modification of the existing 1st stage SCI to place the indication in the reserved bits and be activated with the Resource Pool configuration. Legacy users will discard the unknown bits and the size of reserved bits is configured on the resource pool.

Using the 2nd stage SCI format indication in the 1st stage SCI, which is explicitly an indication for the format of the 2nd stage SCI. This is currently a 2-bit filed where one option is reserved. This reserved option can be reassigned to the ULP-signal indication (or alternatively indicating the absence of 2nd stage SCI). For example, the original table from 38.212-8.3.1.1-1 (v17) can be modified as follow:

| Value of the 2^{nd} stage | |
|---|---|
| SCI format field | 2^{nd} stage SCI format |
| 00 | SCI format 2-A |
| 01 | SCI format 2-B |
| 10 | SCI format 2-C |
| 11 | ULP signaling (or absence of 2^{nd} |
| | stage SCI) |

The indication would by non-ULP non-legacy users as an indication of a ULP signal (or at least of a signal not intended to them), while the legacy device would understand that the format of the 2nd stage SCI is not supported and thus will not attempt to decode the PSSCH.

Using the Additional MCS table indicator field, which indicates the MCS table to use (e.g., tables 8.1.3.1-1 and -2 in 3GPP TS 38.214). Note that the standard 38.214 section 8.3 mentions: “A UE is required to decode neither the corresponding SCI formats 2-A and 2-B nor the PSSCH associated with an SCI format 1-A if the SCI format 1-A indicates an MCS table that the UE does not support.” The tables for MCS table mapping can be either used to refer to a new “MCS table” being the modulation of the ULP signal. Alternatively, we can use the reserved value to indicate that the PSSCH is a ULP transmission. Thus, the non-ULP neighboring users may not try to decode the content.

It is also possible to not include any indication in the 1st stage SCI about the PSSCH content, and when other users attempt to decode the 2nd stage SCI, they will fail and discard the transmission. This solution however costs unnecessary decoding.

### Representative Procedure for ULP Signal Content

When ULP-receiver devices are configured to monitor ULP signals and not monitoring the associated SL resource pool with the regular radio receiver, the ULP-receiver device is not able to read the non-ULP signals, including the PSCCH and PSSCH, if any. The ULP-signal content should carry some pieces of information needed for the ULP devices to understand whether they need to wake up or not, and how to proceed for future transmissions.

Information elements that are needed to be determined by the user receiving the ULP signal may include: information about the identity of the destination (i.e., “should the device wake up”); scheduling of the retransmissions (i.e., “when should the device be up and ready”), and/or information about the identity of the transmitter.

It is worth noting that these are very few of all the information carried out by the 1st and 2nd stage SCIs. The reason for not carrying all the information is that except the scheduling of retransmissions, they relate to the same-slot SL transmission and so are not necessary for the ULP device as it only reads the ULP signal. All necessary information for the actual payload will be repeated in the 1st and 2nd stage SCI of the retransmission.

To overcome the capacity limitation and limited number of sequences a ULP receiver may support, it is possible to compress the acquisition of the ULP payload. The network can transmit sequences that will act as signatures to identify which content is sent.

The mapping between the signature and its corresponding content must be known by the WTRU and is initially received by the main radio using the traditional Uu or SL interface, using for example SIB configuration, RRC signaling or the UE-to-UE configuration as part of the discovery or SL RRC Connection.

All the contents of the ULP signals can be configured depending on users' capabilities. Note that in the Sidelink case, both transmit users and ULP receiver users shall be compatible (as Tx or Rx) to be able to perform the transmission. The ULP format to use is agreed upon during the SL RRC configuration, for example.

The configuration may contain a list of possible contents that may be used by ULP-capable device. The signature for each content may be related to the content (e.g., hashing the content) or simply based on the index of the row in the list.

The signatures may be network-specific, specific to a group of cells within a specific area, a group of users a given resource pool or a given user. Signatures and sequences which may be received by the ULP receiver at any time, using the low-power correlator or receiver, without a need to have predefined scheduling or timing associated with each configuration or signature. Alternatively, signatures may be received by the ULP receiver according to a predefined scheduling sequence. Signatures may also be sent following a reference signal (e.g., LP-PSS and/or LP-SSS) so that the receiver can identify the source of the signature. The timing between the reference signal and the signature can be part of a scheduled/configured sequence.

### Ulp Destination Indication

The ULP signal shall contain indication about the ULP destination ID. This can be a single user ID (as an ULP ID or as a regular user ID), the ID of a group of users (or a shortened single user ID, effectively corresponding to the group of users with similar shortened ID), or a simple single signal acting as broadcast for all the ULP devices. Broadcast or group-based ID require less bits of information to be effective which makes the ULP signal reception more robust and/or requiring less processing but will wake up several unintended users, causing them unnecessary energy consumption.

The destination ID to be used and the associated format in the ULP signal is (pre)configured, as part of the RRC Connection of the user, RRC Connection of the SL pair, or can be configured as part of ULP-specific SIB/RRC.

Upon reception of an ULP signal where the destination ID matches the device, the ULP receiver shall also determine the remaining information in the ULP signals, if any, and prepare to wake up the main radio receiver for the subsequent SL transmissions.

### Reservation Pattern/Configuration

In NR SL Releases 16-17, reservations for retransmissions can be performed up to 32 logical slots ahead in time, using the Time resource assignment field of the 1st stage SCI, which is encoded over 5 or 9 bits. The frequency resource assignment is also encoded over several bits to allow a flexible frequency scheduling (the exact number of bits depends on the number of subchannels in the RP and number of Maximum retransmissions).

The resource reservation assignments of the (re)transmissions being in the 1st Stage SCI, the ULP device that is targeted does not decode this information. However, due to the limited data rates and total number of bits available through the ULP signals (either as signature or explicit data), it is useful the overhead of signaling the reservations as much as possible. The indication of the scheduled retransmissions resource may include all the retransmission resources reserved by the transmitter. Alternatively, the indication may only contain the resource of the first next reservation and the WTRU. This way, the indication is smaller in size and reduces the overhead, and the ULP receiver device shall determine the following reservations, if any, decoding the PSCCH of the retransmissions with its main radio receiver.

One element of the resource reservation is the size of the transmission in the frequency domain. If this information can be detected by the size of the ULP signal by the receiver, and thus deduced and not needed as further dynamically signaled information. As an alternative, the ULP signal may be limited to specific sizes due to hardware or user capabilities. In this case, the ULP signal size in the frequency domain is also known (configured based on capabilities) and thus can be omitted from the ULP signaling.

In one embodiment, the signaling of the time pattern (and frequency pattern if needed) can be performed using a list of time/frequency patterns (pre)configured between the users, e.g., through RRC configuration or Sidelink SIB or ULP SIB. This list is mapped to a list of signatures that are supported by the ULP receiver. The transmitter can send in the ULP signal one such signature so that the receiver can determine the time-frequency pattern used for the retransmissions.

In one example, especially in the case of low data-rate requirements, a single (pre)configured pattern is used for the ULP-based transmissions, which avoids the use of further signaling.

In all the cases, the time and frequency patterns reserved are explicitly provided in the 1st stage SCI (i.e. convert the ULP configuration/signaling information) so that other users reading the PSCCH can understand the same reservation pattern.

### Retransmission Scheduling Considerations

The device performing the resource selection, e.g., at the gNB (Mode 1) or the transmit user (Mode 2) or another scheduling device in case of assisted scheduling, shall prepare the resources needed for the transmissions (both initial transmission and retransmissions), considering both the size required for the embedded ULP-signal and the size of the actual regular PSSCH transmission.

This is made so that the same number of resources are used in all the (re)transmissions, which is required for the SL reservation indication by the specification. For instance, if the ULP signal resource requirement is higher than the PSSCH payload, then the scheduler should modify the transport format of the payload to adapt to the available resources (e.g., by reducing the MCS or adding some padding).

In the case where the ULP signal has a (pre)configured or fixed size, e.g., by requirements on the ULP radio capability, the configuration of the ULP transmissions (either at the connection-level between SL users or at the Resource Pool configuration level) includes the corresponding ULP signal size requirements. Enabling such requirement limits the scheduling flexibility but ease the hardware and processing requirement at the ULP receiver side. One particular case being that the ULP signal may require to occupy an entire Bandwidth Part or an entire Resource Pool if it cannot be multiplexed with other channels/signals in the frequency domain. Another particular case is if the ULP signaling design requires the ULP signal (and possibly some guard bands) to have a fixed size, and the transport block size and MCS will have to be adapted so that the packet transmitted fits in a SL transmission of the same size as the ULP-embedded transmission.

An alternative approach is to decouple the SL ULP signaling from the actual SL data transmission. This way, the SL ULP-embedded transmission can be performed using the resource size that fits the ULP signals (for both its design and the ULP content); and the SL payload can be transmitted using an independent transmission, where the initial and retransmissions are following the regular SL formats and procedures. This approach optimizes the use of the resources but do not let the ULP receiver WTRU know the scheduling information of the payload and has to wake up the main radio to perform blind decoding, that is energy consuming.

### Representative Procedure for Successive ULP-Embedded Transmissions

In this disclosure, so far, it is described an embedding-retransmission scheme where the initial transmission includes the ULP signaling and the subsequent transmissions include the actual payload. In this subsection, we extend the principle so that multiple transmissions can include embedded ULP signaling prior to a subsequent SL payload transmission. In this case, all the transmissions with ULP signaling can be performed using the described SL embedded ULP transmissions slot/format.

The purpose of this extension is to enable more information carrying over the ULP channel. Each ULP transmission having a low data rate, in the case where the content to send over the ULP air interface is larger than the capacity in a single transmission, multiple ULP transmissions can multiply the total number of bits received, at the cost of delay and more overhead and resource usage in the SL resource pool.

This scheme increases the delay to receive the actual data payload, to tradeoff for having better ULP signaling flexibility and control. Note however that in Sidelink, the resource reservation window is bounded by the latency budget and therefore, the resources selected for each (re)transmission in the time should fall within the acceptable delay of the payload, assuming processing time and delays are also within the acceptable packet delay budget.

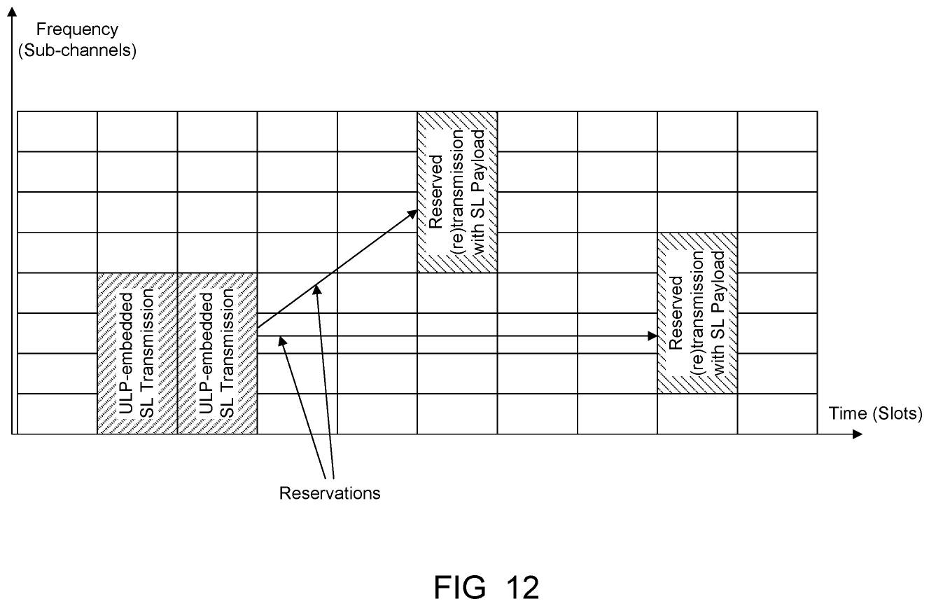

In FIG. 12, an illustrative example is given where a first ULP-embedded transmission of width 4 subchannels is transmitted, reserving resources for two subsequent transmissions. The first retransmission is also a ULP-embedded SL transmission, while the following transmission is payload transmission.

One example of multiple ULP transmissions can be that an initial transmission carries the information about a table of reference to use and the second transmission carries the information about the index of the row in that table. This can be helpful, for example, in the context of resource allocation of SL retransmissions where the number of scheduling possibility for the time and frequency patterns are quite high, and a full flexibility would require a significant number of bits.

The scheduling of successive ULP embedded transmissions can be pre-configured with known time-frequency patterns. The patterns of time-frequency resources are defined within the potential resource reservation window and resource pool available.

Note that if the reservation follows a predefined pattern, the scheduler shall perform an altered resource selection procedure, where the multiple resources of the pattern are jointly selected, to make sure the all the resources of the pattern are available.

In one special case of the above, and to avoid the extra latency of having multiple ULP transmissions before the actual SL payload, the transmitter can schedule the ULP-embedded transmission in consecutive slots so that the ULP payload is decoded as soon as possible without waiting for a subsequent transmission, as illustrated in FIG. 12.

In the case of multiple patterns possible (or if the patterns possible are not predefined), it is also possible to add an indication of the next ULP signal scheduling as part of the ULP signal, as a signature or as explicit data.

Upon reception of a multiple ULP signals, the RX WTRU combines the ULP content to determine the associated information. For example, if a first ULP transmission refers to the signature of a resource pattern table, and the second ULP transmission refers to a table index, the WTRU uses the signaled index in the signaled table to determine the SL resource pattern to use.

### Representative Procedure for ULP-Based SL Small Data Transmission

Another possible use of the ULP embedded transmission is to perform a transmission of an actual payload data using the ULP signal. In some cases, the data to be transmitted is very small and only require few bits. Using the ULP signal to transmit small packets, even with limited data rate, can be an interesting alternative, to avoid the overhead of multiple transmissions, potential reconnection/resynchronization or energy consumption due to using the main radio receiver.

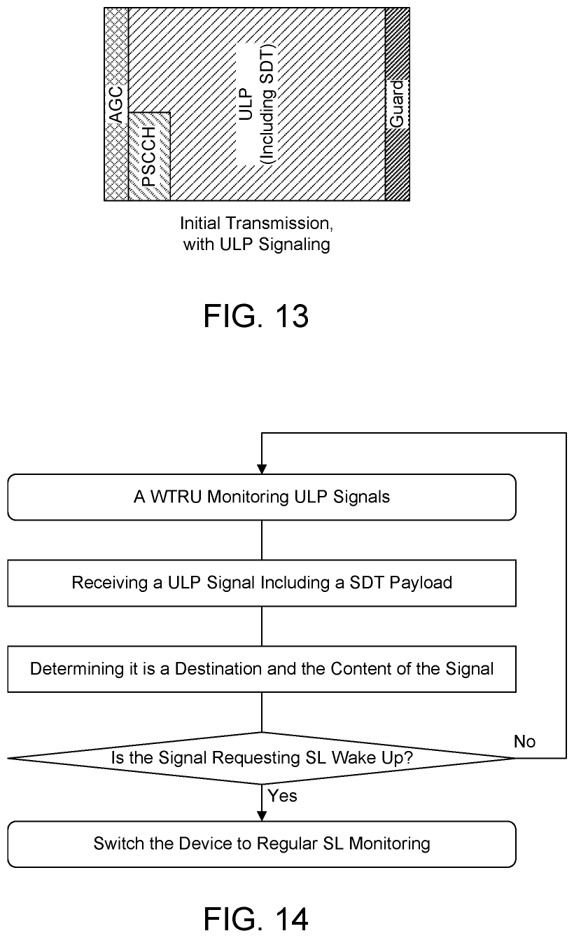

This can use a similar ULP-embedded SL slot structure as presented previously, where the ULP signaling would include the small data transmission, as illustrated in FIG. 13.

The content of the ULP signal can be (pre-)configured to match the application needs for small data payload. This can be done using explicit data transmission that can be decoded by the ULP receiver or tabulated data, i.e., preconfiguring some table of data and only sending the index corresponding to the desired data payload, the index being sent as explicit data or signature.

After the initial transmission including the SDT, the transmitter may prepare a further transmission, either using the regular interface or ULP interface. In that case, a further indication in the ULP signaling can be performed, e.g., using a configured signature, to indicate the interface of the future transmission and/or scheduling information about that transmission. The initial transmission can, in that case, include the reservation of the future transmission in its first stage SCI.

If the initial transmission is a single transmission without planned future transmission, no reservation of resources is needed for the retransmission of data payload using the main radio receiver.

From the receiver point of view, as illustrated in FIG. 14, when monitoring the ULP signals, and receiving a ULP SL SDT signal, the WTRU determines, based on the indications (or absence of indications) in the ULP signal, which interface should be active after the SDT. For example, if no indication is included, then the WTRU can resume ULP monitoring. If there is an indication of wake-up or a scheduled transmission over the regular SL channel, then the WTRU should switch to regular SL monitoring.

This SL ULP small data transmission can also be used jointly with the multiple ULP-embedded transmissions scheme presented previously, to increase the size of the total payload carried by the ULP signals.

### Representative Procedure for Using ULP Signal to Carry 2nd Stage SCI Content

In various embodiments, using ULP signals embedded in the SL slot structure allows the ULP transmission to convey some information. In one embodiment, one or more bits of information can be used to carry parts of the 2nd stage SCI of the subsequent transmissions.

If the ULP signals of the initial transmission carries some information of the 2nd stage SCI of the subsequent transmissions, the subsequent transmission does not need to send these pieces of information again. If enough bits are available in the ULP signals and all the content of 2nd stage SCI can be transmitted in the ULP signal, then the 2nd stage SCI of the subsequent transmission can be completely omitted.

The reduction or absence of 2nd stage SCI in the PSSCH of the subsequent transmissions allows to use the PSSCH entirely for payload and maximizes the capacity of the SL channel.

The full 2nd stage SCI (SCI 2-A, Rel. 16) contains 35 bits of raw information and the total encoded number of bits necessary to transmit the 2nd stage SCI, after CRC, channel coding and rate matching, depends on the transport format of the PSSCH (e.g., MCS). The 2nd stage SCI is mapped to the first resources in frequency and time domain available from the PSSCH.

Depending on the capabilities of the devices, configurations, and situations (such as scheduling and resource availability), it is possible to summarize the different scenarios to share the 2nd Stage SCI content between the ULP-embedded transmission and the subsequent SL transmissions.

Here are three scenarios: A) the ULP Signal carries parts of the information of the 2nd stage SCI of subsequent transmissions without PSSCH in the initial transmission; B) the ULP Signal carries all the information of the 2nd stage SCI of subsequent transmissions without PSSCH in the initial transmission; C) the ULP Signal does not carry information of the 2nd stage SCI of subsequent transmissions without PSSCH in the initial transmission.

Additionally, for co-existence purposes, two additional cases may be derived: A) the ULP Signal carries parts of the information of the 2nd stage SCI of subsequent transmissions and repeated as part of the PSSCH of the initial transmission; B) the ULP Signal carries all the information of the 2nd stage SCI of subsequent transmissions and repeated as part of the PSSCH of the initial transmission.

### A.—ULP Signal Carries Parts of the Information of the 2nd Stage SCI of Subsequent Transmissions

In scenario A, we propose to use the ULP signaling to carry some of the content of the 2nd stage SCI of subsequent transmissions.

Firstly, the ULP signaling is targeting some ULP user(s), from a given transmit user. Depending on the configuration, some level of information about the Source and Destination ID that are usually carried by the 2nd stage SCI can be deduced.

Secondly, the ULP signaling can be configured to carry further contents of the 2nd stage SCI, such as the Cast Type or request for CSI feedback, which can be helpful to know in advance so that the device can prepare the reception accordingly.

A new “partial” 2nd stage SCI format can then be defined. This subformat of 2nd stage SCI includes the data carried by the ULP signaling. The content of this subformat is configured between the users or for a given resource pool, using RRC configuration for example. Which content can be included in the subformat depends on the channel configuration and device capabilities, e.g., the ULP supported data rate.

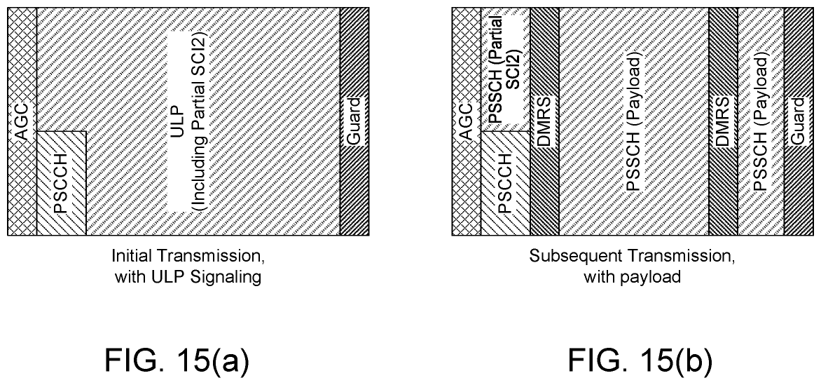

The format of initial and subsequent SL transmissions can be illustrated in FIG. 15, where the 2nd stage SCIs are transmitted partially within the ULP signaling and in the PSSCH of the subsequent transmission. Note that even if only one example of format is given here it can be equally applied to all the formats presented in this disclosure. Note that the split of resources in the PSSCH between partial 2nd stage SCI and payload is not fixed and depends on the SCI content, PSSCH size, and/or transport format.

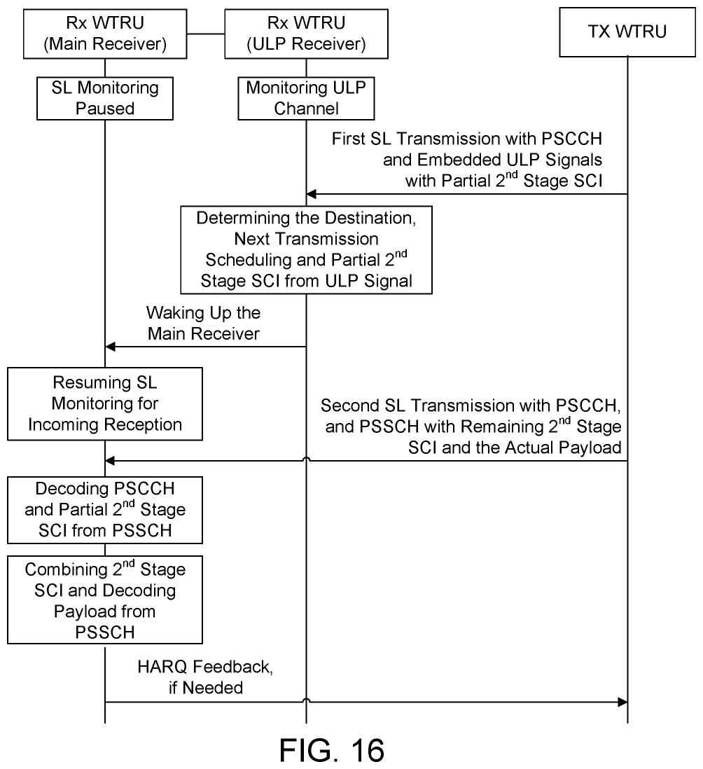

As illustrated in FIG. 16, when receiving the ULP signaling, the receiver determines the content of this partial 2nd stage SCI, based on the configuration.

The remaining content of the 2nd stage SCI of the subsequent transmission are to be grouped in a complementary subformat, that shall be sent in the PSSCH of the subsequent transmission.

Once received the two complementary subformats (one with the ULP signaling and one with the regular SL channel), the WTRU can combine the contents to determine the full 2nd stage SCI and proceed to resume the reception and decoding of the payload, if needed.

In some examples, in the context of ULP signaling, minimizing the amount of data to be transmitted with ULP is critical as the capacity is very limited. To avoid sending some of the contents of the 2nd stage SCI in ULP, some can be preconfigured as part of a table regrouping most commonly expected values.

For example, when a device is configured to monitor ULP instead of directly monitoring the SL channel, it is expected that the device is not actively receiving data (e.g., similar to a RRC IDLE/INACTIVE mode, although this notion is not used for NR SL in existing releases). Thus, values such as NDI, RV and HARQ ID can be expected to be reset to one or few possible values, and thus merging the 7 bits into a few combinations (e.g. very few bits).

In an example, following sub-format content(s) may be used:
HARQ process number—4 bits.
New data indicator—1 bit.
Redundancy version—2 bits.
Source ID—8 bits.
Destination ID—16 bits.

Then the Source and Destination ID can be carried by ULP design to identify the transmission, and the HARQ, NDI and RV can possibly be compressed into, for example, a 2-bit table.

When using a compressed table for ULP transmission, and in the case where the desired configuration is not in that table, the transmitter shall fallback to an explicit transmission, either over the ULP channel if possible, or by transmitting a regular 2nd stage SCI in the PSSCH of the subsequent transmission.

In one embodiment, the presence and/or format of a partial 2nd stage SCI can be indicated as a ULP signature/preamble to let the ULP device expect the reception of the ULP signal containing the partial 2nd stage SCI.

In another embodiment, the possible subformat is not statically configured and different formats can be expected by the ULP receiver, and the ULP signaling indicates (either using codebook or explicit data) the format used. This allows a more dynamic approach, to adapt to the capacity of the ULP signal for each transmission.

In one embodiment above for “ULP signal indications and 1st stage SCI formats”, several options are proposed, including the use of the 2nd stage SCI format indication in the 1st stage SCI to indicate the presence of a ULP signal instead of the PSSCH, which may also mean the absence of a 2nd stage SCI in the PSSCH.

In an initial transmission (the one with the ULP-embedded signal), this indication can clearly indicate that the 2nd stage SCI is not in the PSSCH.

In the subsequent transmission, the 1st stage SCI shall indicate the presence of a subformat of 2nd stage SCI (the complementary subformat that is transmitted over PSSCH), however, if the 4th raw of the 2nd stage format indication is used, it shall be understood by the device as a partial second stage SCI format. This dual meaning (absence and partial SCI format) can be determined by the ULP-receiver device, as it is aware of the scheduling of the subsequent transmission and was preparing to receive that resource.

Other users receiving the indication can attempt to decode the PSSCH to receive a partial 2nd stage SCI and if not able to decode it (e.g., because it was absent), they can simply ignore and discard the data.

In the case where the content of the subformat is not statically configured, the WTRU receiving the partial 2nd stage SCI indication shall decode the 2nd stage SCI subformat in the PSSCH of the subsequent transmission based on the already received information in the ULP signaling.

### B.—ULP Signal Carries all the Information of the 2nd Stage SCI of Subsequent Transmissions

Scenario B is where the ULP Signaling can carry all the content of the 2nd stage SCI. It can be viewed as an extension or special case of scenario A, where the subformat is the entire 2nd stage SCI.

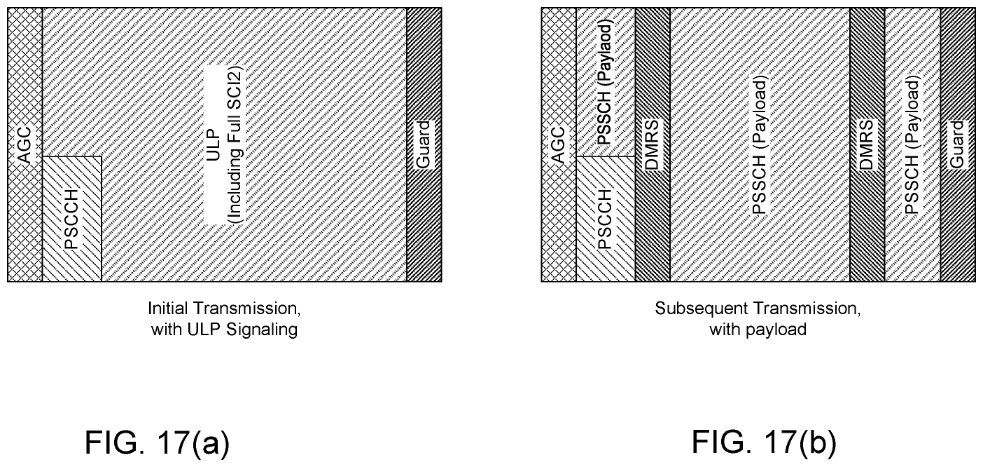

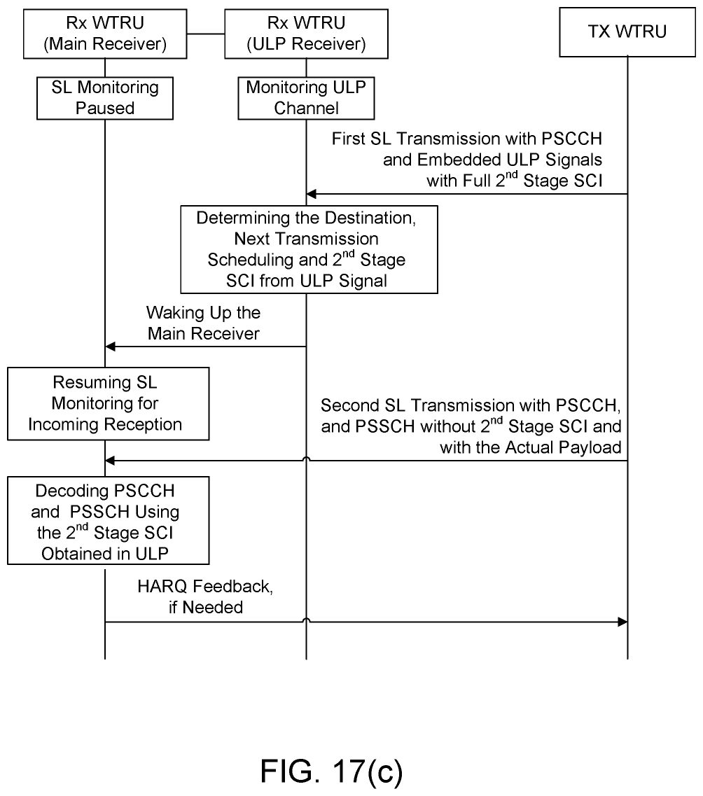

The main difference with scenario A is that the subsequent transmission does not need to send any 2nd stage SCI in the PSSCH, and the configuration (2nd stage SCI) used to decode the payload of the subsequent transmission is coming from the previous ULP-embedded transmission, as illustrated in FIG. 17.

Therefore, the indication of 2nd stage SCI is simplified, as transmitter can indicate the absence of 2nd stage SCI in the 1st stage SCI of both the initial transmission and subsequent transmission.

To be able to carry all the contents of the 2nd stage SCI, the use of preset compression table (i.e., codebooks) is configured as part of the SL ULP signaling configuration between the two users, or for a given resource pool. Only few bits are needed to cover the most likely use cases and can be used to represent the whole 2nd stage SCI. Similarly with the previous subsection, if the desired configuration of 2nd stage SCI is not configured in the preset table, the transmitter may be fallback to a classic transmission of the 2nd stage SCI.

C.—ULP Signal does not Carry Information of the 2nd Stage SCI of Subsequent Transmissions.

In the Scenario C, the ULP signal does not include information about the content of the 2nd stage SCI of the subsequent transmission, except possibly some information from the destination ID for wakeup purposes, and the source ID.

This scenario is the case of the ULP signal being used as a simple wake-up command, and thus improving the reliability or coverage of ULP signaling and/or reduces the complexity and energy consumption of the receiving device.

It is worth noticing, however, that since the ULP signal is configured between a transmit user and targeting some ULP user or group of users, it already carries information about the destination ID. It can also carry information about the source ID if the ULP signals are designed to be source specific. Note that in the case of a broadcasted ULP signal, there is no information about the destination ID.

Thus, a specific subformat of 2nd stage SCI can be defined, that includes the Source ID and destination ID, and where the Source ID and Destination ID are reduced in number of bits carried by the ULP signal. If the Source or Destination IDs included in the legacy 2nd stage SCI can be fully deduced by the ULP Signal, then these fields can be omitted entirely, saving up to 24 bits of information. If the Source ID and Destination ID are not known at all (e.g., if the ULP is a “simple” broadcast), then this subformat is empty and the complementary subformat is the whole regular 2nd stage SCI. As such, Scenario C can also be viewed as a special case of scenario A where the subformat includes nothing (or only the source/destination IDs).

### Co-Existence and Support for Transmissions to Group of Mixed ULP and Non-ULP Receivers

In the proposed SL slot structure so far, if the ULP embedded signaling includes partial or full 2nd stage SCI, non-ULP capable users are not capable of receiving this information and so are not aware of parts of the configuration of the subsequent transmission. Although this is not an issue for unicast transmissions, where the ULP WTRU is the destination of the transmission, it becomes a potential issue for multicast.

In multicast, a group of users are the destination of the transmission. If this group contains a mix of ULP users and non-ULP users, the non-ULP users will not be able to receive the information sent with the ULP signaling.

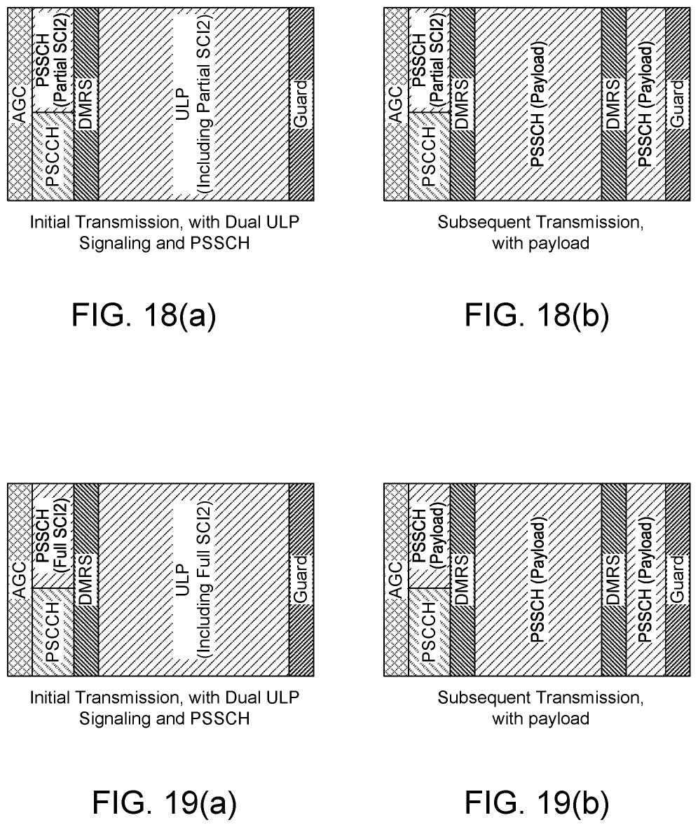

To enable the groupcast between ULP and non-ULP users, and so a better co-existence with other users, we further propose that the initial transmission also carries a PSSCH that contains the partial or full 2nd stage SCI content, in addition to the ULP signaling with the partial or full 2nd stage SCI content. The content of the (partial) 2nd stage SCI in the initial transmission must match between the PSSCH signaling and the ULP signaling so that non-ULP and ULP users collect the complete information. These are the scenarios D (with partial information) and E (with full information) and are illustrated in FIG. 18 and FIG. 19, respectively. Note that a scenario where no 2nd stage SCI information is carried as part of the ULP signal and so no PSSCH is required in the first transmission (or at least where the whole 2nd stage SCI is anyway carried out in the subsequent transmission) is equivalent to Scenario A.

An indication in the 1st stage SCI must be indicated to let non-ULP users determine that the 2nd stage SCI that is (partially) in the PSSCH of the initial transmission is actually targeting the payload of the retransmission.

An implicit indication can be made if, when determining the presence of ULP signaling in the 1st stage SCI, the users assume that one or few formats of 2nd stage SCI are transmitted in a short PSSCH. This can be done by (pre)configuration. If a single (sub)format of 2nd stage SCI is configured, then the decoding is straight-forward, while if several (sub)formats are possible (e.g., no 2nd stage SCI and one or multiple subformat(s)), then the user has to try and blind-decode the correct format.

Explicit indication can be also performed, with the possibility in the 1st stage SCI to indicate both the ULP signaling and the format. These indications can be performed using the “reserved” indications of the 1st stage SCI to add, for example, a ULP signal indication and a subformat can be indicated using the remaining raw of the 2nd stage SCI table indication.

The users, when determining the presence of the ULP signaling, shall assume that the 2nd stage SCI content, if any, relates to the subsequent transmission.

Adding a PSSCH in the initial transmission, other users of the resource pool can now decode information about the transmission and not simply discard the whole transmission.

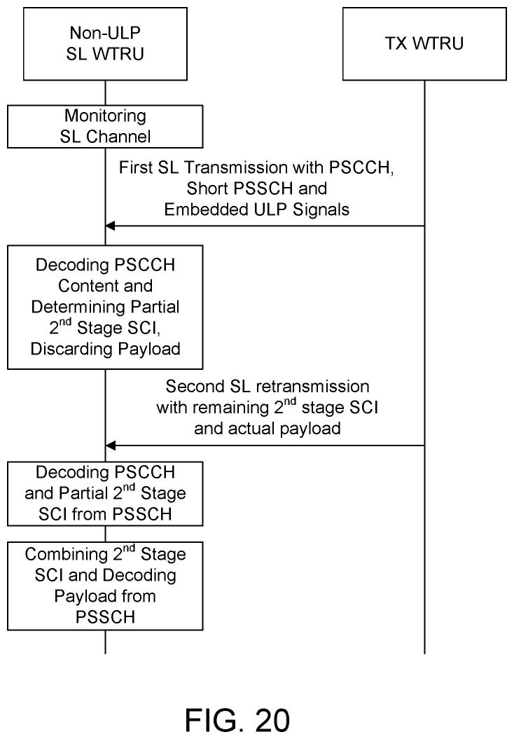

As illustrated in FIG. 20, the non-ULP user can first receive the initial transmission including the PSCCH and the PSSCH (with 2nd stage SCI), determine the presence of a (partial) 2nd stage SCI that shall be used for the subsequent transmission, decode the partial or full 2nd stage SCI from the PSSCH and discard the remaining resource (ULP); then, when the subsequent transmission comes with the remaining content of the 2nd stage SCI (if any), the non-ULP user can combine the two parts of the 2nd stage SCI (if it was partial) and finally be able to decode the payload if needed (i.e., if it is a destination).

In one alternative, it is also possible for the PSSCH of the initial transmission to transmit the regular complete 2nd stage SCI of the subsequent transmission—even if the ULP signaling carries only parts of it—to reduce the number of formats designed in the specification. The non-ULP user can decode the 2nd stage SCI in the initial transmission, store it, and also decode the partial 2nd stage SCI (if any) in the subsequent transmission before decoding the payload.

### Selection Procedure(s)

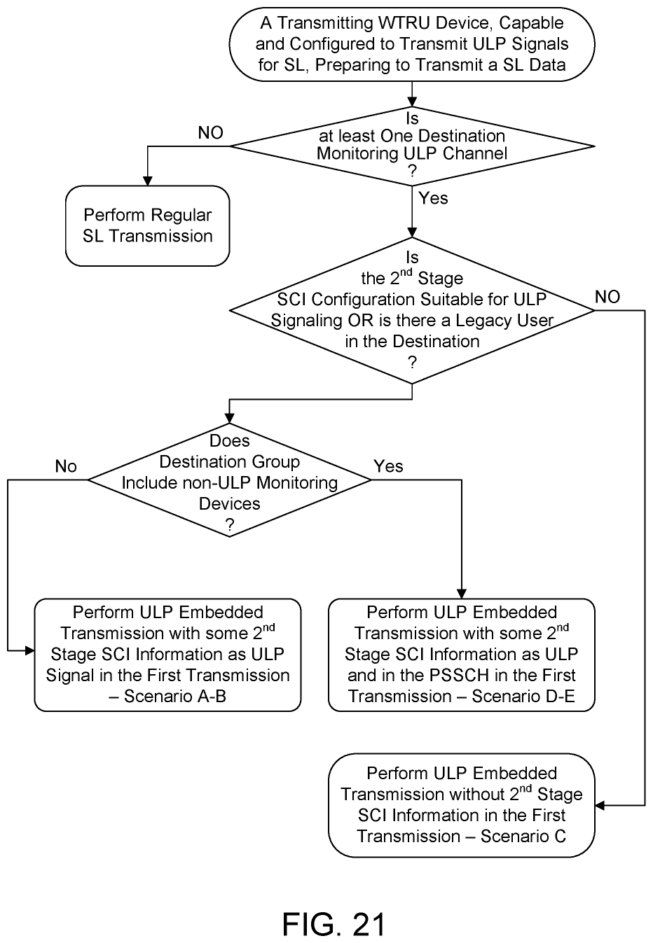

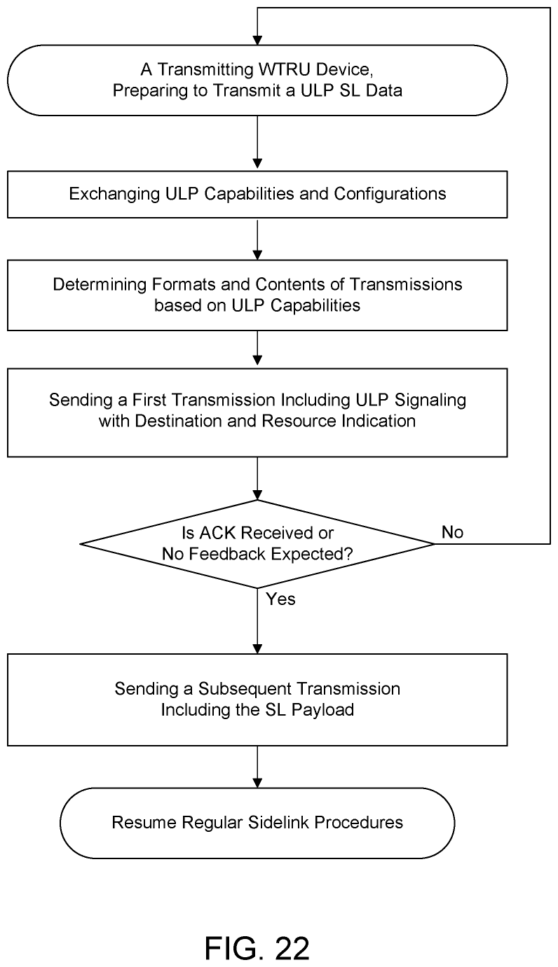

In this subsection, we describe a selection procedure that can be used to determine the type and formats for the partial 2nd stage SCI transmission in ULP and SL. The summarized flowchart is illustrated in FIG. 21. Note that the following is described with the intent to cover the case of a transmission targeting several users (i.e., groupcast) but this stands true for the transmission toward a single destination with some simplifications.

When a transmitting SL device is capable and configured to transmit ULP signals, it must decide which format is suitable for the transmission, assuming several (sub)formats of 2nd stage SCI are available.

When preparing the transmission, the transmitting device shall first check whether the receiver or receiver group includes devices that are configured to monitor ULP signals, i.e., whether some destinations are not monitoring the channel with regular SL radio. If all the intended destinations are monitoring the channel in a regular way, the transmitter shall simply use a regular SL transmission.

Otherwise, i.e., if at least one receiver is configured to monitor the ULP signals, the transmitter shall use ULP signals. We now need to determine which (sub)format to use.

The transmitter shall check whether, among the destinations, some devices are not monitoring the ULP signals. This is to know if the initial transmission needs to repeat the content transmitted using the ULP signals as regular SL transmission using the subformat of 2nd stage SCI in the PSSCH.

If all the destinations are monitoring the ULP signals, then the transmitter can use the ULP embedded structure without the need to repeat information in the PSSCH of the initial transmission. One last check is to verify whether the ULP signaling configured can support to transmit the desired 2nd stage SCI content. For instance, if there is a preset list of subformat configured that do not include all the possible combinations, it is possible that the 2nd stage SCI desired is not part of the preset list. In that case, a fallback to Scenario C must be performed. If the 2nd stage SCI for the transmission suits the configuration, then the transmitter can use the ULP signal to carry some of the content of the 2nd stage SCI, which corresponds to scenario A or B.

If some destinations are not monitoring the ULP signals (i.e., the case of a mixed group of ULP and non-ULP devices) then the information sent over ULP and PSSCH shall match. In that case, one more verification is to ensure if the non-ULP monitoring devices are legacy device, in which case they will not understand the newly proposed subformat. In that case, the transmission shall include all the 2nd stage SCI content as part of the subsequent transmission, and so this is the scenario C.

If the destination group is mixed ULP and non-ULP monitoring devices but are all capable of decoding and processing the new subformats, then we can include the subformats in the ULP and PSSCH of the initial transmission. The transmitter shall check whether the 2nd stage SCI selected suits the configuration for transmitting SCI content over ULP signals. If this is suitable, then this corresponds to scenario D or E. Otherwise the transmitter falls back to Scenario C.

Representative Procedure for Embedding ULP Signals for in-Band SL Transmissions

The following provides exemplary embodiment for the point of view of two different types of devices: the transmitting devices and the ULP-receiver device.

A Sidelink TX user supporting transmissions towards ULP SL users. In an example, a first WTRU communicating with one or more second WTRUs is configured to perform any of the following: exchanging the SL and ULP transmission capabilities and configuration with the second WTRUs; determining a first format of a first transmission and a second format of subsequent transmissions based on the ULP capability of one or more of the second WTRUs; determining a first 1st stage SCI indicating reserved resources of the subsequent transmissions and indicating the first format, wherein the first format includes a ULP signal, e.g., ULP signature(s)/preamble(s); sending the first transmission including the first 1st stage SCI and the ULP signal targeting the one or more of the second WTRUs; determining a second 1st stage SCI indicating reserved resources of the subsequent transmissions and indicating the second format, wherein the second format includes a 2nd stage SCI and a payload; and/or sending the subsequent transmissions of the second format according to the reserved resources indicated in the first transmission, including the second 1st stage SCI, the 2nd stage SCI and the data payload.

The capabilities including supported signatures/preambles and packets and supported SCI formats over the resource pool, can be exchanged as part of the discovery procedure or UE to UE connection/setup (e.g., SL RRC configuration). The ULP signaling may further include information about the reserved resources of one or more of the subsequent transmissions. The format and content of the ULP signals is based on the supported (pre)configurations and signatures, resource selection (supported BW) and destination user capabilities (e.g., supported data rates), as well as whether any of the destination is currently monitoring ULP channel. The initial transmission (ULP-embedded transmission) is repeated in one or multiple reserved subsequent transmission(s), and the actual payload transmission (PSCCH+PSSCH) is transmitted in one or multiple further subsequent transmission(s).

The ULP message is split over one or more sidelink ULP-embedded transmissions which may be consecutive or non-consecutive in time, e.g., a first transmission including a ULP signature indicating a table of indexing and a second transmission including a ULP signature indicating an index in the table. A subsequent transmission can further reserve resources for more retransmissions, beyond the initially reserved set of resources, and the further retransmissions can be either repeating the first transmission (i.e. PSCCH+ULP channel) or the subsequent transmissions (PSCCH+PSSCH). The determination of the format and content and scheduling of the transmissions is performed by a different WTRU (e.g., by a gNB, a relay node, or an assisting UE) that transmits to the SL TX user the assignment/grant that includes the format, contents, and scheduling of the SL transmissions to perform.

In an example, the initial transmission with the ULP signaling is performed by a first user, while the subsequent transmission is performed by a third user (e.g., the case where an assisting device, e.g., Road Side Unit, another WTRU etc., performs the ULP wake up signal on behalf of the user with the payload to transmit).

In an example, after sending the first transmission and before the transmission of the second transmission, the first WTRU receives a feedback from the second WTRU acknowledging the decoding of the ULP signal, and can proceed to transmit the subsequent transmission. In an example, after sending the first transmission and before the transmission of the second transmission, the first WTRU does not receive a feedback from the second WTRU (or receives a NACK) and shall proceed to a fallback solutions, e.g. restarting procedure or report to the network. In an example, after the sending of the subsequent transmission, in the case where no feedback is received from the second WTRU while it was expected, the first WTRU shall proceed to a fallback solutions, e.g. restarting procedure or report to the network.

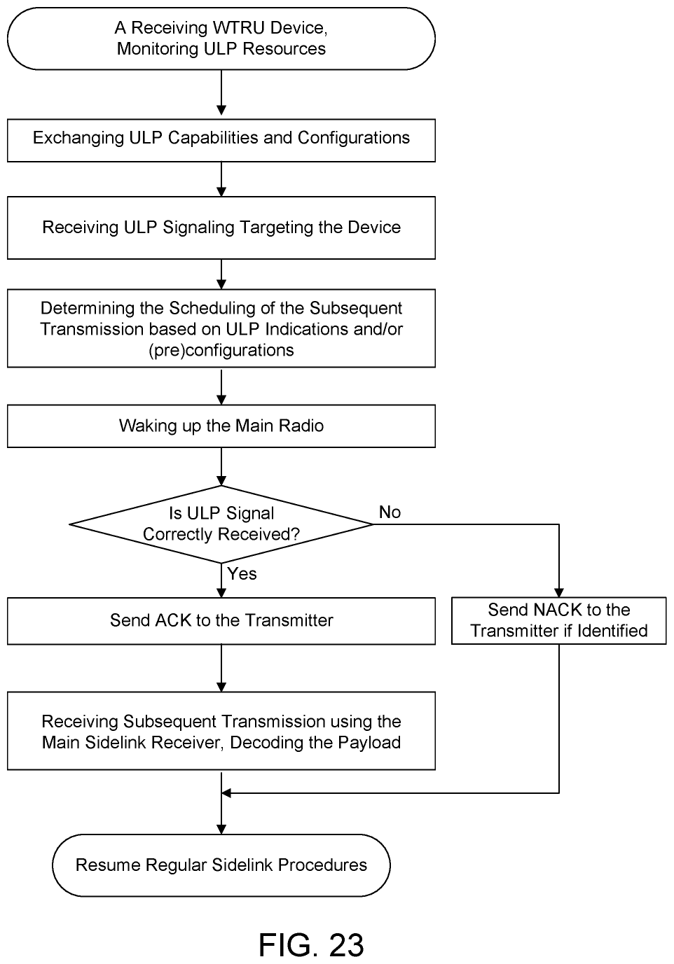

An exemplary flowchart including the feedback after ULP transmission is provided and illustrated in FIG. 23:

A WTRU with ULP receiver acting as a Sidelink a receiver. A first WTRU monitoring signals from one or more second WTRU(s) is configured to perform any of the following: exchanging the SL and ULP transmission capabilities and configuration with the second WTRUs; receiving a ULP signal, e.g., one or more ULP signature(s) or preamble(s), and detecting a configured (e.g., unique or group) identifier; determining scheduled resources of a subsequent SL transmission based on the received ULP signal; and/or waking up the main sidelink radio, utilizing it to receive the scheduled subsequent transmission, and decode the payload data and resume the regular Sidelink data/control procedures.

In an example, ULP capabilities and SL configuration including supported signatures/preambles and supported SCI formats over the resource pool, can be exchanged as part of the discovery procedure or UE to UE connection/setup (e.g., SL RRC configuration). The determination of the reserved SL transmission resource is based on pre-configuration or received ULP SL configuration, e.g., using resource patterns. The determination of the reserved SL transmission resource is based on the determination of the reserved SL transmission resource is based on received ULP indication. The determination of the reserved SL transmission resource is based on a combination of on pre-configuration or received ULP SL configuration and received ULP indication. The ULP message is received over multiple transmissions, each in following sidelink ULP-embedded transmissions, and the content is decoded based on these multiple ULP signal transmission, e.g., a first transmission including a ULP signature indicating a table of indexing and a second transmission including a signature indicating the index of the table.

In an example, upon successful decoding of the ULP signal(s) and waking up the main radio, the first WTRU sends an acknowledgement feedback to the second WTRU. In an example, upon successful identification of the targeted identifier but failure of decoding the remaining ULP signal(s) and waking up the main radio, the first WTRU sends a non-acknowledgement feedback to the second WTRU, if identified. In an example, upon successful decoding of the ULP signal(s) and SL payload, and in the case where no ACK feedback is required, the first WTRU sends a confirmation to the second WTRU to indicate its status.

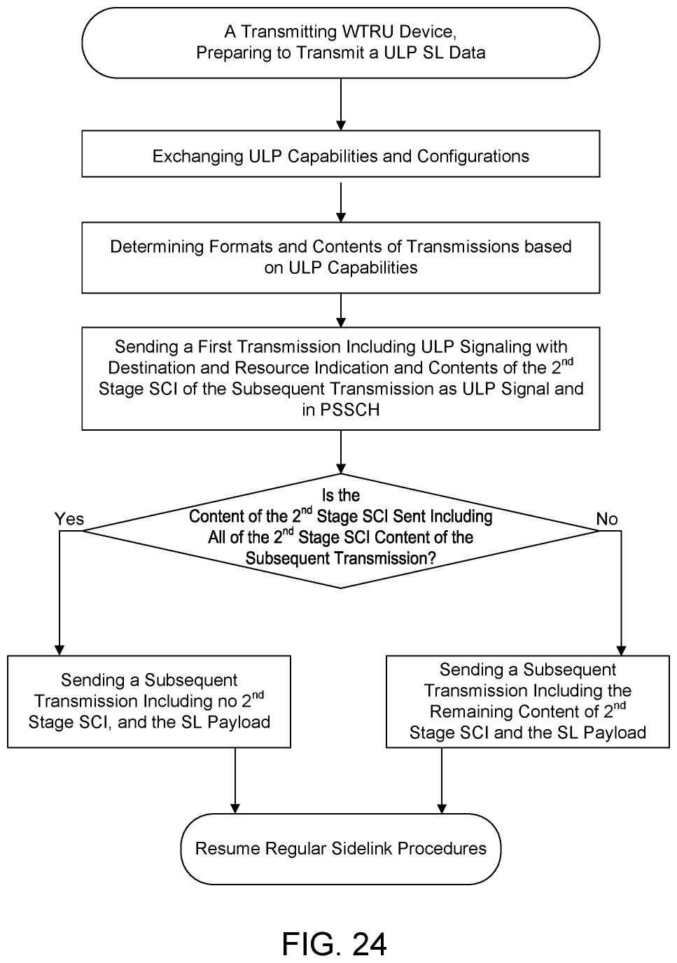

An exemplary flowchart including the feedback after ULP transmission is provided and illustrated in FIG. 24.

### Representative Procedure for Using SL ULP Signal to Carry 2nd Stage SCI Contents

The following provides exemplary embodiments corresponding to scenarios A, B, C, D and E for the point of view of three different types of devices: the transmitting devices, the ULP-receiver device and a non-ULP non-legacy device.

A Sidelink TX user supporting transmissions towards ULP SL users. A first WTRU communicating with one or more second WTRUs is configured to perform any of the following:
exchanging the SL and ULP transmission capabilities and configuration with the second WTRUs.
determining a first format of a first transmission and a second format of subsequent transmissions based on the ULP capability of one or more of the second WTRUs.
determining a first 1st stage SCI indicating reserved resources of the subsequent transmissions and indicating the first format, wherein the content of the first format includes a ULP signal, e.g., ULP signature(s)/preamble(s), and a first content of a 2nd stage SCI based on the payload of the subsequent transmission.
sending the first transmission including the first 1st stage SCI, the first content of the 2nd stage SCI, and the ULP signal targeting the one or more of the second WTRUs.
determining a second 1st stage SCI indicating reserved resources of the subsequent transmissions and indicating the second format, wherein the second format includes a second content of the 2nd stage SCI and a payload.
sending the subsequent transmissions of the second format according to the reserved resources and first content of 2nd stage SCI indicated in the first transmission, including the second 1st stage SCI, the second content of the 2nd stage SCI, and the data payload.

In an example, the first and second contents of the 2nd stage SCI applies to the payload of the subsequent transmission. In an example, the format and contents of the 2nd stage SCI is based on the supported 2nd stage SCI (pre)configurations and signatures, resource selection (supported BW) and destination user capabilities (e.g., supported data rates), as well as whether the destination is currently monitoring ULP channel. In an example, the second content of the 2nd stage SCI includes the remaining content of a regular 2nd stage SCI format, that was not included in the first content.

In an example, the determination of the format and content step results in that the usage of partial 2nd stage SCI is not suitable, e.g. due to unindexed content or too long message for ULP capabilities; and so the transmitting the first transmission steps does not include a first content of the 2nd stage SCI in the ULP signaling nor in the PSSCH; and the transmitting the subsequent transmission as a regular SL transmissions with the complete 2nd stage SCI. In an example, the determination of the format step results in that the usage of partial 2nd stage SCI is not suitable due to the presence of legacy destination users; and the transmitting the subsequent transmission as a regular SL transmission with full 2nd stage SCI. In another example, the determination of the format and contents of the 2nd stage SCI step results in that the first content includes the full 2nd stage SCI; and so the subsequent transmissions includes an indication of no 2nd stage SCI in PSSCH and do not carry the 2nd stage SCI in the PSSCH; and the decoding of the SL payload is done using the 2nd stage SCI content receive in the first transmission.

Note that the examples of the TX WTRU in previous section(s) also apply for this WTRU.

A WTRU with ULP receiver and Sidelink—as a receiver. A first WTRU monitoring signals from one or more second WTRU(s) is configured to perform any of the following:
exchanging the SL and ULP transmission capabilities and configuration with the second WTRUs.
receiving a ULP signal, e.g., one or more ULP signature(s) or preamble(s), and detecting a configured, e.g., unique or group, identifier.
determining scheduled resources of a subsequent SL transmission based on the received ULP signal, and determining the first content of the 2nd stage SCI.
waking up the main sidelink radio, utilizing it to receive the scheduled subsequent transmission, including the 2nd content of the 2nd stage SCI and the payload.
decoding the payload based on the combination of the first and second contents of the 2nd stage SCI.

In an example, the determination of the contents and formats of the 2nd stage SCI the subsequent transmission is based on any of the ULP signal received and indications in the 1st stage SCI of the subsequent transmission. In an example, the ULP signal does not carry 2nd stage SCI content, and so the regular radio receives the 2nd stage SCI content of the subsequent transmissions as part of the subsequent transmission itself. In an example, the ULP signal carry the entire 2nd stage SCI, and so the device determines that no 2nd stage SCI is carried in the subsequent transmission, and the device uses the ULP-carried 2nd stage SCI content to decode the PSSCH payload of the subsequent transmission.

Note that the examples of the RX WTRU in previous section also apply for this WTRU.

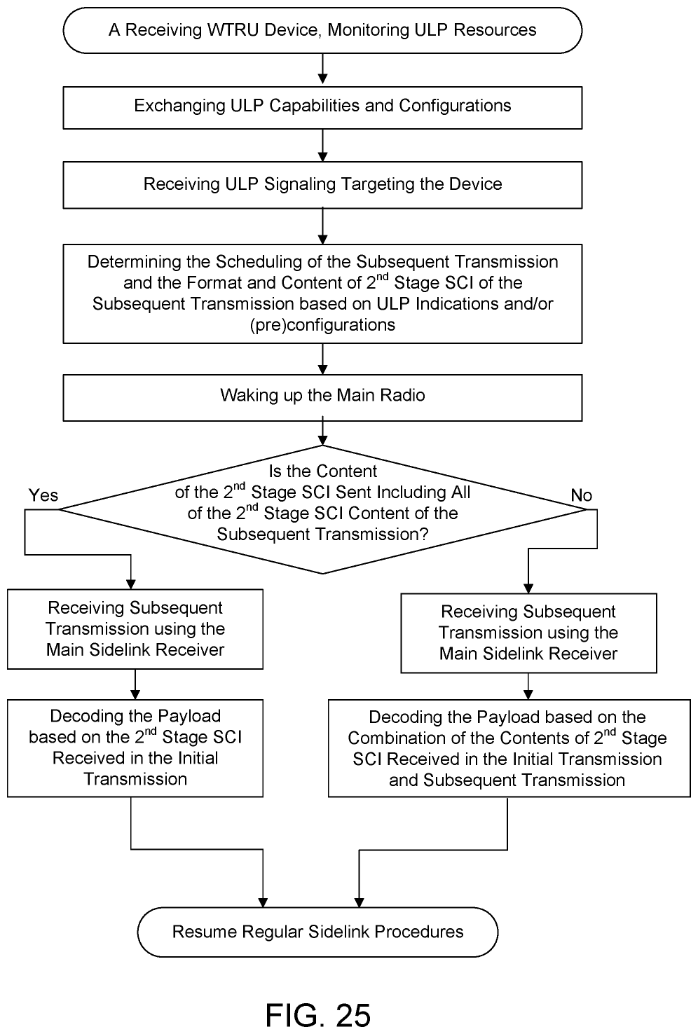

An exemplary flowchart of the WTRU receiver with ULP is provided and illustrated in FIG. 25.

A WTRU without ULP receiver—as a receiver. A first WTRU monitoring signals from one or more second WTRUs is configured to perform any of the following:
exchanging the SL capabilities and configuration with the second WTRUs.
receiving a SL transmission and determining scheduled resources of a subsequent SL transmission and a first format based on indications in the 1st stage SCI, wherein the first format indicates a ULP embedded signal.
determining a first content of the 2nd stage SCI, and discarding the ULP signal, based on the determined first format.
receiving the scheduled subsequent transmission and determining a second format, wherein the second format indicates a second content of the 2nd stage SCI and a payload.
determining a second content of the 2nd stage SCI based on the determined second format;
receiving and decoding the payload based on the combination of the first and second content of the 2nd stage SCI.

In an example, capabilities including supported SCI formats over the resource pool, and can be exchanged as part of the discovery procedure or UE to UE connection/setup (e.g., SL RRC configuration). In an example, upon determination that the user is not a destination of the payload, the user discards the PSSCH content of the transmissions also includes flushing the received signal of the initial transmission (e.g., for HARQ soft-combining). In an example, the received and indicated content and format of the 2nd stage SCI in the initial transmission is the full 2nd stage format for the subsequent transmission; storing the 2nd stage SCI; receiving the subsequent transmission and using the stored 2nd stage SCI content to decode the payload. In an example, the received and indicated content and format of the 2nd stage SCI for the subsequent transmission in the initial transmission is absent; receiving the subsequent transmission including the 2nd stage SCI and decoding the payload. In an example, upon determination of an unknown or unsupported format of 1st or 2nd stage SCI, the device shall discard the content.

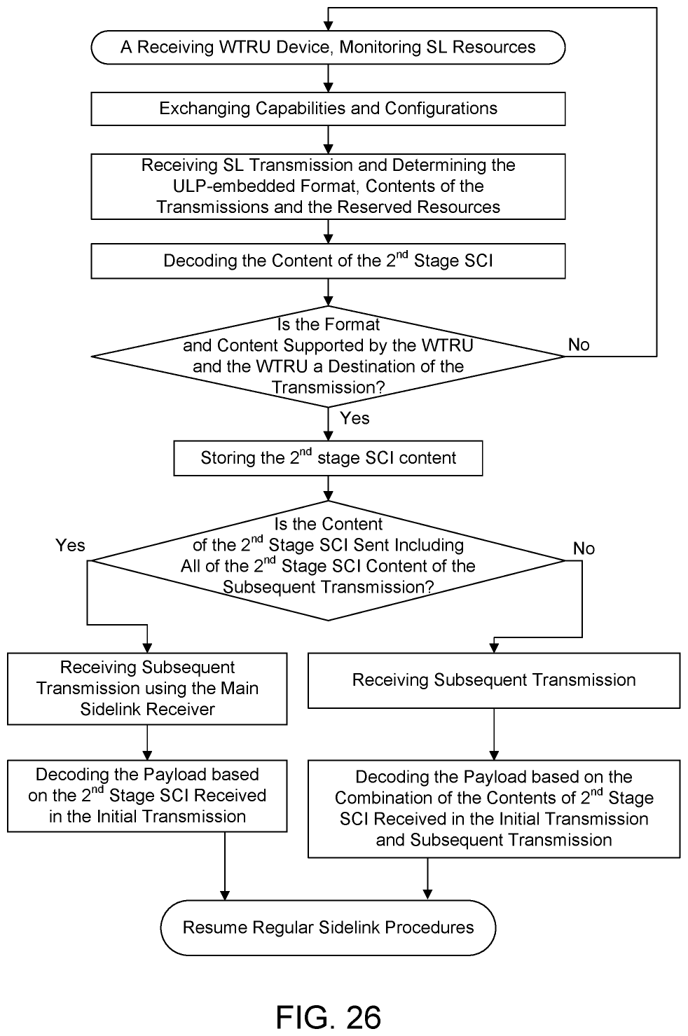

An exemplary flowchart of a non-ULP receiver of a WTRU is provided and illustrated in FIG. 26.

### Representative Procedure for ULP-Based Sidelink Small Data Transmission

A Sidelink TX user supporting SDT transmissions towards ULP SL users. A first WTRU communicating with one or more second WTRUs is configured to perform any of the following:
exchanging the SL and ULP transmission capabilities and configuration with the second WTRUs.
determining a first format of a first transmission based on the ULP capability of one or more of the second WTRUs.
determining a first 1st stage SCI indicating the first format, wherein the first format includes a ULP signal, e.g., ULP signature(s)/preamble(s).
sending the first transmission including the first 1st stage SCI and the ULP signal targeting the one or more of the second WTRUs, including the SDT content.

In an example, capabilities including supported ULP signatures/preambles, SDT configurations and supported SCI formats over the resource pool, and can be exchanged as part of the discovery procedure or UE to UE connection/setup (e.g., SL RRC configuration). In an example, the first transmission further indicates that the second WTRU shall wake up its main radio receiver to expect subsequent transmissions.

In an example, the first transmission further indicates resource reservation for subsequent transmissions.

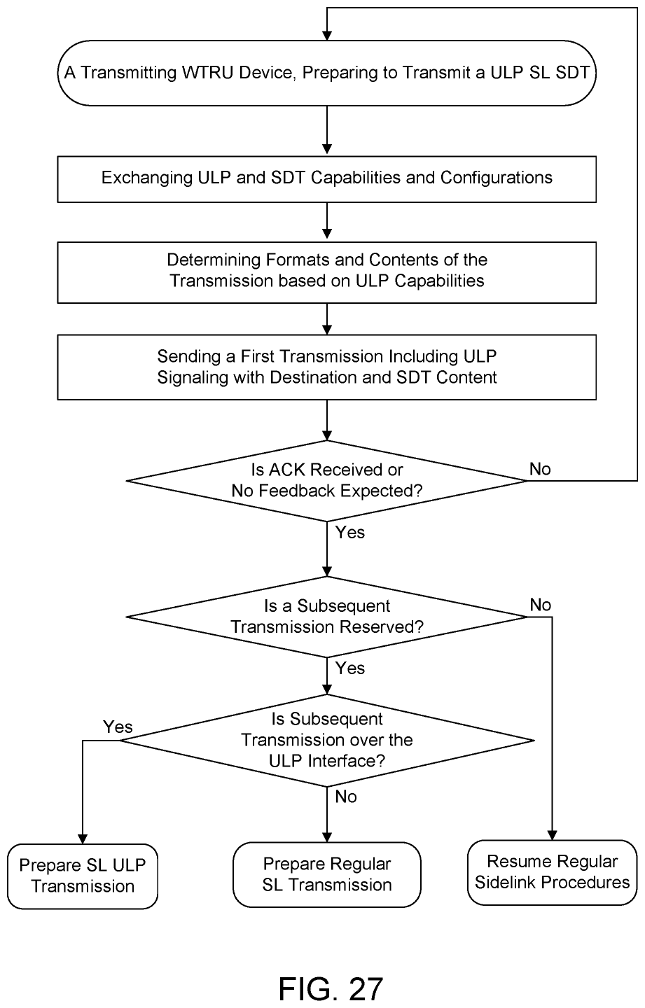

An exemplary flowchart of a SL ULP SDT transmitter of a WTRU is provided and illustrated in FIG. 27.

A WTRU with ULP receiver and Sidelink—as a receiver:

A first WTRU monitoring signals from one or more second WTRU(s) is configured to perform any of the following:
exchanging the SL and ULP transmission capabilities and configuration with the second WTRUs.
receiving a ULP signal, e.g., one or more ULP signature(s) or preamble(s), and detecting a configured, e.g., unique or group, identifier.
determining a small data transmission format based on the received ULP signal.
decoding the small data payload based on the configuration and received indications.

In an example, capabilities including supported signatures/preambles, SDT configurations and supported SCI formats over the resource pool, and can be exchanged as part of the discovery procedure or UE to UE connection/setup (e.g., SL RRC configuration). In an example, the first WTRU further determine the scheduling of subsequent transmissions based on the received ULP signaling. In an example, the first WTRU further determine the reception of an indication to wake up the main radio receiver and use it to further monitor the SL channel.

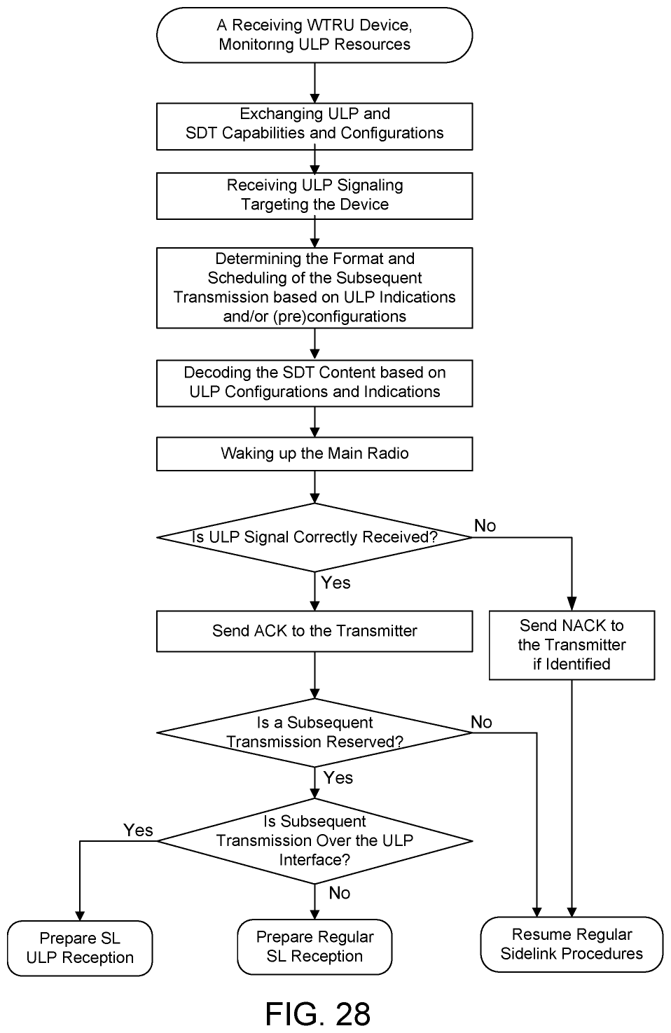

An exemplary flowchart of an ULP SDT receiver of a WTRU is provided and illustrated in FIG. 28.

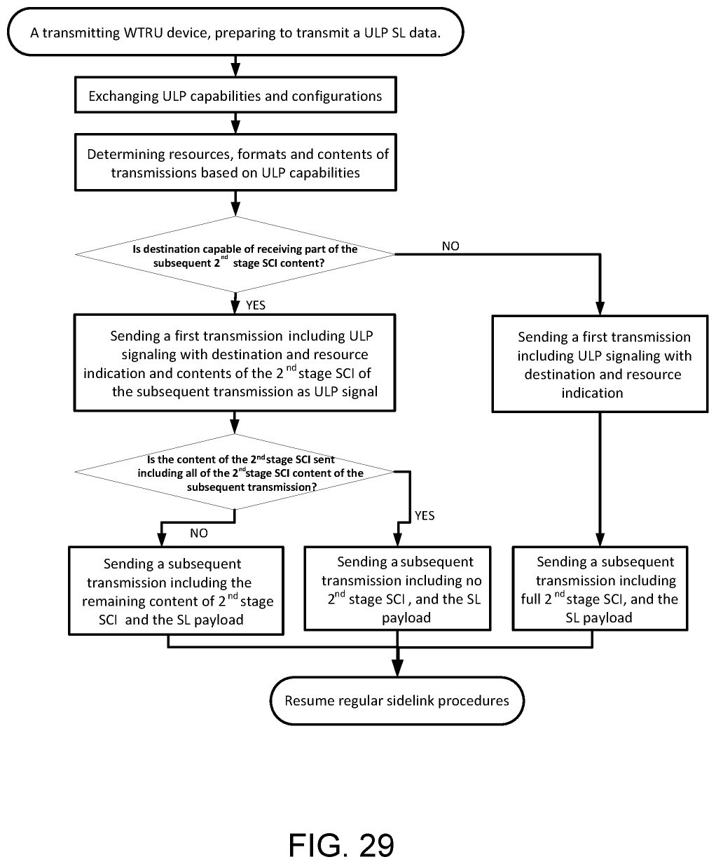

Referring to FIG. 29, an example of an SL scheduling and transmission procedure having SL ULP signaling is provided. In this example, a WTRU determines the scheduling for SL initial transmission and re-transmission(s) with an initial SL ULP wakeup signal (WUS). Based on the capability of receiver(s) (e.g., data rate and ULP reception availability), the WTRU determines the format and content of the initial transmission, including a ULP signal, and the format and content of the re-transmission(s). The ULP signal may indicate targeted WTRU(s), scheduled subsequent SL transmission(s) resources and parts of the 2nd stage SCI of the subsequent transmission(s). The 1st stage SCI of the initial SL transmission may indicate the same reserved resources and the presence of an embedded ULP signal. The re-transmission(s) may include a 1st stage SCI indicating the partial 2nd stage SCI format, the partial 2nd stage SCI, and/or the SL payload. The WTRU may transmit the initial transmission and re-transmission(s) according the scheduled resources, where the re-transmissions include the SL payload.

In another example, the full content of 2nd stage SCI may be sent in the ULP signal and removed from the subsequent transmission(s), for example, when ULP data rate allows. In some cases, the same (partial or full) content of the 2nd stage SCI may be sent in the ULP signal and a PSSCH of the initial transmission, when the destination is mixed with ULP WTRU(s) and non-ULP WTRU(s).

In one embodiment, the WTRU may determine, based on ULP capability associated with one or more target destinations, information of a first transmission and a second transmission. The WTRU may transmit, based on the information, the first transmission including 1) a first SCI associated with the first transmission, the first SCI indicates a set of resources for the second transmission and a ULP signal to be transmitted on the first transmission, and 2) the ULP signal indicating the one or more target destinations, the set of resources for the second transmission, and at least a first subset of a second SCI associated with the second transmission. The WTRU may further transmit the second transmission including at least a second subset of the second SCI and sidelink payload data.

In one embodiment, a method implemented by the WTRU for wireless communications includes determining, based on ULP capability associated with one or more target destinations, information of a first transmission and a second transmission; transmitting, based on the information, the first transmission including 1) a first SCI associated with the first transmission, the first SCI indicates a set of resources for the second transmission and a ULP signal to be transmitted on the first transmission, and 2) the ULP signal indicating the one or more target destinations, the set of resources for the second transmission, and a second SCI associated with the second transmission; and transmitting the second transmission including sidelink payload data.

In another embodiment, a method implemented by the WTRU for wireless communications includes determining, determining, based on ULP capability associated with one or more target destinations, information of a first transmission and a second transmission; determining that the one or more target destinations are not capable of receiving a subset of SCI; transmitting, based on the information, the first transmission including a ULP signal indicating the one or more target destinations and the set of resources for the second transmission; and transmitting the second transmission including the SCI and sidelink payload data.

Although the features and elements of the present invention are described focusing a single TX WTRU, the case where another device is performing the scheduling for the transmit SL user, e.g., the gNB in NR SL Mode 1, a relay node, or another user scheduling for this user in the context of cooperation, then the embodiments pertaining to the transmit user can be altered so that a scheduling node is performing the determination and preparation steps, and transmits the grant or scheduling to the transmit user, prior to its first transmission.

Another alternative case is where a sidelink user (e.g. a sidelink user, a road-side unit, a user cluster head) is performing the SL ULP transmission to wake up the ULP device, while another sidelink user is performing the SL data transmission (i.e. a node that is able to wake a ULP device on behalf of another node).

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

What is claimed is:

1-22. (canceled)

23. A method implemented by a wireless transmit/receive unit (WTRU) for wireless communications, the method comprising:
determining, based on ultra-low power (ULP) capability associated with one or more target destinations, information of a first transmission and a second transmission;
transmitting, based on the information, the first transmission including 1) a first sidelink control information (SCI) associated with the first transmission, wherein the first SCI indicates a set of resources for the second transmission and a ULP signal to be transmitted on the first transmission, and 2) the ULP signal indicating the one or more target destinations, the set of resources for the second transmission, and at least a first subset of a second SCI associated with the second transmission; and
transmitting the second transmission including at least a second subset of the second SCI and sidelink payload data.

24. The method of claim 23, further comprising determining that the one or more target destinations are capable of receiving a subset of the second SCI.

25. The method of claim 23, wherein the one or more target destinations comprise at least a ULP WTRU and a non-ULP WTRU.

26. The method of claim 23, wherein the first subset of the second SCI is sent in the ULP signal and on a physical sidelink shared channel (PSCCH) of the first transmission.

27. The method of claim 23, wherein the first SCI is a first stage SCI, and the second SCI is a second stage SCI.

28. The method of claim 23, wherein the second transmission includes the first SCI indicating a format of the second SCI.

29. A method implemented by a wireless transmit/receive unit (WTRU) for wireless communications, the method comprising:
determining, based on ultra-low power (ULP) capability associated with one or more target destinations, information of a first transmission and a second transmission;
transmitting, based on the information, the first transmission including 1) a first sidelink control information (SCI) associated with the first transmission, wherein the first SCI indicates a set of resources for the second transmission and a ULP signal to be transmitted on the first transmission, and 2) the ULP signal indicating the one or more target destinations, the set of resources for the second transmission, and a second SCI associated with the second transmission; and
transmitting the second transmission including sidelink payload data.

30. The method of claim 29, wherein the ULP signal indicates a full content of the second SCI.

31. The method of claim 29, further comprising determining that the one or more target destinations are capable of receiving a subset of the second SCI.

32. The method of claim 29, wherein the one or more target destinations comprise at least a ULP WTRU and a non-ULP WTRU.

33. The method of claim 29, wherein the first subset of the second SCI is sent in the ULP signal and on a physical sidelink shared channel (PSCCH) of the first transmission.

34. The method of claim 29, wherein the first SCI is a first stage SCI, and the second SCI is a second stage SCI.

35. The method of claim 29, wherein the second transmission includes the first SCI indicating a format of the second SCI.

36. A wireless transmit/receive unit (WTRU) comprising circuitry, including a transmitter, a receiver, a processor, and memory, configured to:
determine, based on ultra-low power (ULP) capability associated with one or more target destinations, information of a first transmission and a second transmission;
transmit, based on the information, the first transmission including 1) a first sidelink control information (SCI) associated with the first transmission, wherein the first SCI indicates a set of resources for the second transmission and a ULP signal to be transmitted on the first transmission, and 2) the ULP signal indicating the one or more target destinations, the set of resources for the second transmission, and at least a first subset of a second SCI associated with the second transmission; and
transmit the second transmission including at least a second subset of the second SCI and sidelink payload data.

37. The WTRU of claim 36, wherein the processor is further configured to determine that the one or more target destinations are capable of receiving a subset of the second SCI.

38. The WTRU of claim 36, wherein the one or more target destinations comprise at least a ULP WTRU and a non-ULP WTRU.

39. The WTRU of claim 36, wherein the first subset of the second SCI is sent in the ULP signal and on a physical sidelink shared channel (PSCCH) of the first transmission.

40. The WTRU of claim 36, wherein the first SCI is a first stage SCI, and the second SCI is a second stage SCI.

41. The WTRU of claim 36, wherein the second transmission includes the first SCI indicating a format of the second SCI.

42. The WTRU of claim 36, wherein the processor is further configured to determine, based on the ULP capability associated with the one or more target destinations, a first format of the first transmission and a second format of the second transmission.
